(19) United States
(12) Patent Application Publication
(10) Pub. No.: US 2008/0254387 A1
(43) Pub. Date: Oct. 16, 2008

(54) NEGATIVE-WORKING IMAGEABLE ELEMENTS AND METHODS OF USE

(76) Inventors: Jianfei Yu, Fort Collins, CO (US); Kevin B. Ray, Fort Collins, CO (US); Paul R. West, Fort Collins, CO (US)

Correspondence Address: Andrew J. Anderson, Patent Legal Staff,;Eastman Kodak Company, 343 State Street, Rochester, NY, 14650-2201, US

(21) Appl. No.: 11/734,796

(22) Filed: Apr. 13, 2007

(51) Int. Cl. G03C 1/00

(52) U.S. Cl. 430/287.1

(57) ABSTRACT

A radiation-sensitive composition includes an initiator composition, a radiation absorbing compound, and a particulate primary polymeric binder that has a backbone comprising multiple urethane moieties and further comprises side chains comprising free radically polymerizable groups attached to the backbone. This primary polymeric binder can be used in place of or in addition to a conventional free radically polymerizable component. This composition can be used to provide negative-working imageable elements that can be imaged and developed to provide lithographic printing plates.

### FIELD OF THE INVENTION

This invention relates to radiation-sensitive compositions and imageable elements such as negative-working lithographic printing plate precursors. The invention also relates to methods of using these imageable elements.

### BACKGROUND OF THE INVENTION

Radiation-sensitive compositions are routinely used in the preparation of imageable materials including lithographic printing plate precursors. Such compositions generally include a radiation-sensitive component, an initiator system, and a binder, each of which has been the focus of research to provide various improvements in physical properties, imaging performance, and image characteristics.

Recent developments in the field of printing plate precursors concern the use of radiation-sensitive compositions that can be imaged by means of lasers or laser diodes, and more particularly, that can be imaged and/or developed on-press. Laser exposure does not require conventional silver halide graphic arts films as intermediate information carriers (or “masks”) since the lasers can be controlled directly by computers. High-performance lasers or laser-diodes that are used in commercially-available image-setters generally emit radiation having a wavelength of at least 700 nm, and thus the radiation-sensitive compositions are required to be sensitive in the near-infrared or infrared region of the electromagnetic spectrum. However, other useful radiation-sensitive compositions are designed for imaging with ultraviolet or visible radiation.

There are two possible ways of using radiation-sensitive compositions for the preparation of printing plates. For negative-working printing plates, exposed regions in the radiation-sensitive compositions are hardened and unexposed regions are washed off during development. For positive-working printing plates, the exposed regions are dissolved in a developer and the unexposed regions become an image.

Various radiation compositions and imageable elements containing reactive polymer binders are described in U.S. Pat. No. 6,569,603 (Furukawa) and EP 1,182,033A1 (Fujimaki et al.). The reactive polymer binders include reactive vinyl groups that are pendant to the polymer backbone. Other IR-sensitive compositions are described in U.S. Pat. No. 6,309,792 (Hauck et al.), U.S. Pat. No. 6,893,797 (Munnelly et al.), U.S. Pat. No. 6,787,281 (Tao et al.), and U.S. Pat. No. 6,899,994 (Huang et al.), U.S. Patent Application Publication 2003/0118939 (West et al.), and EP 1,079,276A1 (Lifka et al.) and EP 1,449,650A1 (Goto).

Various negative-working imageable elements containing either urethane polymers or polymers with ethylenically unsaturated side chains are described, for example, in U.S. Pat. No. 6,916,595 (Fujimaki et al.), U.S. Pat. No. 6,702,437 (Fujimaki et al.), and U.S. Pat. No. 6,727,044 (Fujimaki et al.), Japanese Kokai 2000-187322 (Mitsubishi Chemical Co.), and U.S. Patent Application Publications 2004/0131972 (Fujimaki et al.), 2005/0031986 (Kakino et al.), 2006/0068328 (Aimura et al), and 2006/0199097 (Oda et al.).

### Problem to be Solved

The various radiation sensitive compositions of the art can readily be used to prepare negative-working imageable elements but they generally require the use of a post-exposure baking step (“pre-heat” step) to enhance good adhesion and run length. Omitting the post-exposure baking step can result in complete image failure following development with alkaline developers or during on-press development. During long print runs, they may show a loss of highlight dots long before solid image areas show signs of wear or degradation.

In addition, some negative-working compositions show insufficient resistance to the various chemicals and solvents they are in contact with during development or printing.

It would be desirable in the industry to have highly sensitive negative-working imageable compositions and elements that provide good run length but that can also be prepared for use without a post-exposure baking step. It would also be desirable to have a radiation-sensitive composition and imageable element that has improved solvent resistance and run length.

### SUMMARY OF THE INVENTION

The present invention provides a radiation-sensitive composition comprising:
an initiator composition capable of generating free radicals sufficient to initiate polymerization of free radically polymerizable groups upon exposure to imaging radiation,
a radiation absorbing compound, and
a particulate primary polymeric binder that has a backbone comprising multiple urethane moieties and further comprises free radically polymerizable side chains attached to the backbone.

This invention also provides an imageable element comprising a substrate having thereon an imageable layer comprising:
an initiator composition capable of generating free radicals sufficient to initiate polymerization of free radically polymerizable groups upon exposure to imaging radiation,
a radiation absorbing compound, and
a particulate primary polymeric binder that has a backbone comprising multiple urethane moieties and further comprises free radically polymerizable side chains attached to the backbone,
the imageable element optionally also comprising an overcoat disposed over the imageable layer.

This invention also provides a method comprising:
A) imagewise exposing the imageable element of this invention using imaging radiation to produce exposed and non-exposed regions, and
B) with or without a post-exposure baking step, developing the imagewise exposed element to remove only the non-exposed regions.

The radiation-sensitive compositions and imageable elements of this invention provide imaged elements with high sensitivity, good shelf life, and improved solvent resistance and run length without the need for a post-exposure baking step. In addition, we found that our radiation-sensitive compositions can be used without the need for the conventional polymerizable monomers or oligomers that may cause tackiness in the coatings and thus hinder storability. Thus, such conventional monomers and oligomers can be omitted. However, in some embodiments, they can be included. This feature provides more flexibility for designing negative-working imageable elements with various properties and for various uses.

These advantages are achieved by our radiation-sensitive compositions that include a particulate primary polymeric binder that has a backbone comprising multiple urethane moieties as well as free radically polymerizable side chains attached to the backbone. This primary polymeric binder can desirably serve as both the predominant or sole polymeric binder as well as the primary source of free radically polymerizable groups in the imageable composition and layer.

### DETAILED DESCRIPTION OF THE INVENTION

### Definitions

Unless the context indicates otherwise, when used herein, the terms “radiation-sensitive composition”, “imageable element”, “lithographic printing plate precursor”, and “printing plate precursor” are meant to be references to embodiments of the present invention.

In addition, unless the context indicates otherwise, the various components described herein such as “primary polymeric binder”, “initiator”, “co-initiator”, “free radically polymerizable component”, “radiation absorbing compound”, “secondary polymeric binder”, “nonionic phosphate acrylate”, and similar terms also refer to mixtures of such components. Thus, the use of the articles “a”, “an”, and “the” is not necessarily meant to refer to only a single component.

The term “single-layer imageable element” refers to an imageable element having only one imageable layer that is essential to imaging, but as pointed out in more detail below, such elements may also include one or more layers under or over (such as a topcoat) the imageable layer to provide various properties.

Moreover, unless otherwise indicated, percentages refer to percents by dry weight.

For clarification of definitions for any terms relating to polymers, reference should be made to “Glossary of Basic Terms in Polymer Science” as published by the International Union of Pure and Applied Chemistry (“IUPAC”), Pure Appl. Chem. 68, 2287-2311 (1996). However, any definitions explicitly set forth herein should be regarded as controlling. “Graft” polymer or copolymer refers to a polymer having a side chain that has a molecular weight of at least 200.

The term “polymer” refers to high and low molecular weight polymers including oligomers and includes homopolymers and copolymers.

The term “copolymer” refers to polymers that are derived from two or more different monomers.

The term “backbone” refers to the chain of atoms (carbon or heteroatoms) in a polymer to which a plurality of pendant groups are attached. One example of such a backbone is an “all carbon” backbone obtained from the polymerization of one or more ethylenically unsaturated polymerizable monomers. However, other backbones can include heteroatoms wherein the polymer is formed by a condensation reaction or some other means.

### Radiation-Sensitive Compositions

The radiation-sensitive compositions may have any utility wherever there is a need for a coating that is polymerizable using suitable radiation, and particularly where it is desired to remove unexposed regions of the coated and irradiated or exposed composition. The radiation-sensitive compositions can be used to prepare an imageable layer in imageable elements such as printed circuit boards for integrated circuits, microoptical devices, color filters, photomasks, and printed forms such as lithographic printing plate precursors that are defined in more detail below, as well as in paint compositions, coating finishes, and molding compositions.

The radiation-sensitive compositions comprise one or more radically polymerizable primary polymeric binders. These primary polymeric binders can be “self-crosslinkable”, by which we mean that a separate free radically polymerizable component is not necessary. Such binders have a backbone comprising multiple (at least two) urethane moieties. In some embodiments, there are at least two of these urethane moieties in each backbone recurring unit. The primary polymeric binders also include side chains attached to the backbone, which side chains include one or more free radically polymerizable groups (such as ethylenically unsaturated groups) that can be polymerized (crosslinked) in response to free radicals produced by the initiator composition (described below). There may be at least two of these side chains per molecule. As used herein, these primary polymer binders are also considered the “primary radically polymerizable component” because “secondary radically polymerizable components” (as described below) can also be present.

The primary polymeric binder also has desired solvent resistance as measured when 0. 1 g remains insoluble when it is agitated (for example, stirred or shaken) for 24 hours at 20° C. in an aqueous solution of either 2-butoxyethanol or 4-hydroxy-4-methyl-2-pentanone (20% water).

In addition, the primary polymeric binders are substantially free of unreacted isocyanate functional groups, which means that there is less than 0.01 mol of such groups per mole of free radically polymerizable groups in the side chains.

The free radically polymerizable groups (or ethylenically unsaturated groups) can be part of aliphatic or aromatic acrylate side chains attached to the polymeric backbone. Generally, there are at least 2 and up to 20 such groups per molecule, or typically from 2 to 10 such groups per molecule.

The primary polymeric binders generally have a molecular weight (Mₙ) of at least 2,000 and typically at least 100,000 to about 500,000, or from about 100,000 to about 300,000, as determined by dynamic light scattering.

In addition, the glass transition temperature (Tg) of the particulate primary polymeric binder is generally from about 10 to about 70° C., and in some embodiments, the Tg is from about 25 to about 70° C.

The primary polymeric binders are present in the radiation-sensitive composition (or imageable layer) in particulate form, meaning that they exist at room temperature as discrete particles, for example in an aqueous dispersion. However, the particles can also be partially coalesced or deformed, for example at temperatures used for drying coated imageable layer formulations. Even in this environment, the particulate structure is not destroyed. In most embodiments, the average particle size is from about 10 to about 300 nm and typically the average particle size is from about 30 to about 150 nm. The particulate primary polymeric binder is generally obtained commercially and used as an aqueous dispersion having at least 20% and up to 50% solids. It is possible that primary polymeric binder is at least partially crosslinked among urethane moieties in the same or different molecules, which crosslinking could have occurred during polymer manufacture. This still leaves the free radically polymerizable groups available for reaction during imaging.

The primary polymeric binder is generally present in the radiation-sensitive composition in an amount of at least 10%, and typically from about 25 to about 90 %, based on the total composition (or imageable layer) dry weight. These binders may comprise up to 100% of the dry weight of all polymeric binders (including any secondary polymeric binders).

Useful primary polymeric binders can also comprise hydrophilic groups including but not limited to, carboxy, sulfo, or phospho groups, either attached directly to the backbone or attached as part of side chains other than the free radically polymerizable side chains. In most embodiments, the hydrophilic groups, such as carboxy groups, are directly attached to the backbone.

While not intending to limit the scope of the invention, a representative backbone recurring unit of a primary polymeric binder can be illustrated by the following schematic diagram (BINDER UNIT) that shows a single backbone recurring unit inside the brackets, and “n” represents sufficient number of the same or different backbone recurring units to provide a minimum molecular weight, as noted above, of at least 2,000. In (BINDER UNIT), the oval blocks can represent polyester acrylate, epoxy acrylate, or polyether acrylate groups, the square blocks can represent diisocyanate groups, and the rectangular blocks can represent monomeric diol (such as hexane diol) or polymeric diol groups. The illustrated backbone recurring unit has two urethane moieties and at least one hydrophilic carboxy group that is directly attached to the backbone.

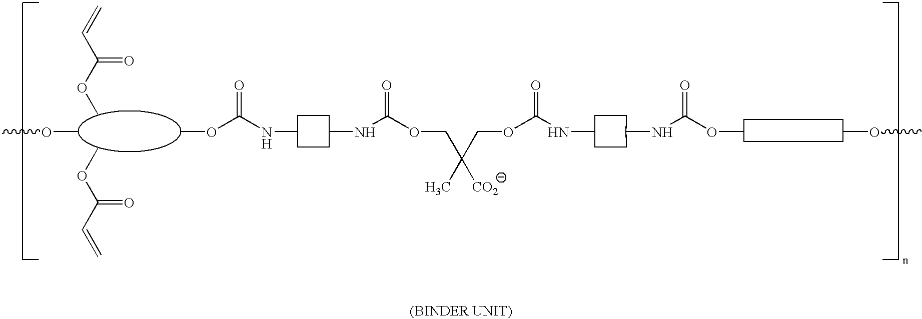

Useful commercial products that comprise primary polymeric binders useful in this invention include but are not limited to, Bayhydrol® UV VP LS 2280, Bayhydrol® UV VP LS 2282, Bayhydrol® UV VP LS 2317, Bayhydrol® UV VP LS 2348, and Bayhydrol® UV XP 2420, that are all available from Bayer MaterialScience, as well as Laromer™ LR 8949, Laromer™ LR 8983, and Laromer™ LR 9005, that are all available from BASF.

When these primary polymeric binders are the only free radically polymerizable component, the radiation-sensitive compositions (and imageable layers) consist essentially of such polymeric binders, an initiator composition capable of generating free radicals sufficient to initiate polymerization of free radically polymerizable groups upon exposure to imaging radiation, and a radiation absorbing compound.

In some embodiments, however, the radiation-sensitive composition (and imageable layer) can further comprise one or more different (or secondary) free radically polymerizable components, each of which contains one or more free radically polymerizable groups that can be polymerized using free radical initiation. For example, such secondary free radically polymerizable components can contain one or more free radical polymerizable monomers or oligomers having one or more addition polymerizable ethylenically unsaturated groups, crosslinkable ethylenically unsaturated groups, ring-opening polymerizable groups, azido groups, aryldiazonium salt groups, aryldiazosulfonate groups, or a combination thereof. Similarly, crosslinkable polymers having such free radically polymerizable groups can also be used.

Suitable ethylenically unsaturated compounds that can be polymerized or crosslinked include ethylenically unsaturated polymerizable monomers that have one or more of the polymerizable groups, including unsaturated esters of alcohols, such as acrylate and methacrylate esters of polyols. Oligomers and/or prepolymers, such as urethane acrylates and methacrylates, epoxide acrylates and methacrylates, polyester acrylates and methacrylates, polyether acrylates and methacrylates, and unsaturated polyester resins can also be used. In some embodiments, the secondary free radically polymerizable component comprises carboxy groups.

Useful secondary free radically polymerizable components include free-radical polymerizable monomers or oligomers that comprise addition polymerizable ethylenically unsaturated groups including multiple acrylate and methacrylate groups and combinations thereof, or free-radical crosslinkable polymers. Free radically polymerizable compounds include those derived from urea urethane (meth)acrylates or urethane (meth)acrylates having multiple polymerizable groups. For example, a free radically polymerizable component can be prepared by reacting DESMODUR® N100 aliphatic polyisocyanate resin based on hexamethylene diisocyanate (Bayer Corp., Milford, Conn.) with hydroxyethyl acrylate and pentaerythritol triacrylate. Useful free radically polymerizable compounds include NK Ester A-DPH (dipentaerythritol hexaacrylate) that is available from Kowa American, and Sartomer 399 (dipentaerythritol pentaacrylate), Sartomer 355 (di-trimethylolpropane tetraacrylate), Sartomer 295 (pentaerythritol tetraacrylate), and Sartomer 415 [ethoxylated (20)trimethylolpropane triacrylate] that are available from Sartomer Company, Inc.

Numerous other secondary free radically polymerizable compounds are known to those skilled in the art and are described in considerable literature including Photoreactive Polymers: The Science and Technology of Resists, A Reiser, Wiley, N.Y., 1989, pp. 102-177, by B. M. Monroe in Radiation Curing: Science and Technology, S. P. Pappas, Ed., Plenum, New York, 1992, pp. 399-440, and in “Polymer Imaging” by A. B. Cohen and P. Walker, in Imaging Processes and Material, J. M. Sturge et al. (Eds.), Van Nostrand Reinhold, New York, 1989, pp. 226-262. For example, useful secondary free radically polymerizable components are also described in EP 1,182,033A1 (noted above), beginning with paragraph [0170], and in U.S. Pat. No. 6,309,792 (Hauck et al.), U.S. Pat. No. 6,569,603 (Furukawa), and U.S. Pat. No. 6,893,797 (Munnelly et al.).

The secondary free radically polymerizable component can be present in the radiation-sensitive composition at a weight ratio to the primary polymeric binder (described above) of from about 5:95 to about 95:5, from about 10:90 to about 90:10, or from about 30:70 to about 70:30. For example, the secondary free radically polymerizable component can be present in an amount of at least 10 and up to and including 70% based on the total solids in the radiation sensitive composition, or the total dry weight of the imageable layer.

The radiation-sensitive composition also includes an initiator composition that is capable of generating free radicals sufficient to initiate polymerization of all the various free radically polymerizable components (both the primary binder and optional secondary free radically polymerizable components) upon exposure of the composition to imaging radiation. The initiator composition is generally responsive to electromagnetic imaging radiation in the ultraviolet, visible, infrared, or near infrared spectral regions, corresponding to the spectral range of at least 150 nm and up to and including 1500 nm. More typically, they are responsive to either UV (or “violet”) radiation at a wavelength of from about 150 to about 475 nm or to infrared radiation of at least 700 nm and up to and including 1400 nm. Initiator compositions are used that are appropriate for the desired imaging wavelength(s).

In general, suitable initiator compositions comprise compounds that include but are not limited to, amines (such as alkanol amines), thiol compounds, anilinodiacetic acids or derivatives thereof, N-phenyl glycine and derivatives thereof, N,N-dialkylaminobenzoic acid esters, N-arylglycines and derivatives thereof (such as N-phenylglycine), aromatic sulfonylhalides, trihalogenomethylsulfones, imides (such as N-benzoyloxyphthalimide), diazosulfonates, 9,10-dihydroanthracene derivatives, N-aryl, S-aryl, or O-aryl polycarboxylic acids with at least 2 carboxy groups of which at least one is bonded to the nitrogen, oxygen, or sulfur atom of the aryl moiety (such as aniline diacetic acid and derivatives thereof and other “co-initiators” described in U.S. Pat. No. 5,629,354 of West et al.), oxime ethers and oxime esters (such as those derived from benzoin), α-hydroxy or α-amino-acetophenones, alkyltriarylborates, trihalogenomethylarylsulfones, benzoin ethers and esters, peroxides (such as benzoyl peroxide), hydroperoxides (such as cumyl hydroperoxide), azo compounds (such as azo bis-isobutyronitrile), 2,4,5-triarylimidazolyl dimers (also known as hexaarylbiimidazoles, or “HABI's”) as described for example in U.S. Pat. No. 4,565,769 (Dueber et al.), boron-containing compounds (such as tetraarylborates and alkyltriarylborates) and organoborate salts such as those described in U.S. Pat. No. 6,562,543 (Ogata et al.), and onium salts (such as ammonium salts, diaryliodonium salts, triarylsulfonium salts, aryldiazonium salts, and N-alkoxypyridinium salts). Other known initiator composition components are described for example in U.S Patent Application Publication 2003/0064318 (noted above).

Co-initiators can also be used, such as metallocenes (such as titanocenes and ferrocenes), polycarboxylic acids, haloalkyl triazines, thiols, or mercaptans (such as mercaptotriazoles), borate salts, and photooxidants containing a heterocyclic nitrogen that is substituted by an alkoxy or acyloxy group, as described in U.S. Pat. No. 5,942,372 (West et al.).

Useful IR-sensitive radiation-sensitive compositions include an onium salt including but not limited to, a sulfonium, oxysulfoxonium, oxysulfonium, sulfoxonium, ammonium, selenonium, arsonium, phosphonium, diazonium, or halonium salt. Further details of useful onium salts, including representative examples, are provided in U.S. Patent Application Publication 2002/0068241 (Oohashi et al.), WO 2004/101280 (Munnelly et al.), and U.S. Pat. No. 5,086,086 (Brown-Wensley et al.), U.S. Pat. No. 5,965,319 (Kobayashi), and U.S. Pat. No. 6,051,366 (Baumann et al.). For example, suitable phosphonium salts include positive-charged hypervalent phosphorus atoms with four organic substituents. Suitable sulfonium salts such as triphenylsulfonium salts include a positively-charged hypervalent sulfur with three organic substituents. Suitable diazonium salts possess a positive-charged azo group (that is —N═N⁺). Suitable ammonium salts include a positively-charged nitrogen atom such as substituted quaternary ammonium salts with four organic substituents, and quaternary nitrogen heterocyclic rings such as N-alkoxypyridinium salts. Suitable halonium salts include a positively-charged hypervalent halogen atom with two organic substituents. The onium salts generally include a suitable number of negatively-charged counterions such as halides, hexafluorophosphate, thiosulfate, hexafluoroantimonate, tetrafluoroborate, sulfonates, hydroxide, perchlorate, n-butyltriphenyl borate, tetraphenyl borate, and others readily apparent to one skilled in the art.

The halonium salts are useful such as the iodonium salts. In one embodiment, the onium salt has a positively-charged iodonium, (4-methylphenyl)[4-(2-methylpropyl)phenyl]-moiety and a suitable negatively charged counterion. A representative example of such an iodonium salt is available as Irgacure® 250 from Ciba Specialty Chemicals (Tarrytown, N.Y.) that is (4-methylphenyl)[4-(2-methylpropyl)phenyl]iodonium hexafluorophosphate and is supplied in a 75% propylene carbonate solution.

Useful boron-containing compounds include organic boron salts that include an organic boron anion such as those described in the noted U.S. Pat. No. 6,569,603 that is paired with a suitable cation such as an alkali metal ion, an onium, or a cationic sensitizing dye. Useful onium cations for this purpose include but are not limited to, ammonium, sulfonium, phosphonium, iodonium, and diazonium cations. Iodonium salts such as iodonium borates are useful as initiator compounds in radiation-sensitive compounds that are designed for “on-press” development (described in more detail below). They may be used alone or in combination with various co-initiators such as heterocyclic mercapto compounds including mercaptotriazoles, mercaptobenzimidazoles, mercaptobenzoxazoles, mercaptobenzothiazoles, mercaptobenzoxadiazoles, mercaptotetrazoles, such as those described for example in U.S. Pat. No. 6,884,568 (Timpe et al.) in amounts of at least 0.5 and up to and including 10 weight % based on the total solids of the radiation-sensitive composition. Useful mercaptotriazoles include 3-mercapto-1,2,4-triazole, 4-methyl-3-mercapto-1,2,4-triazole, 5-mercapto-1-phenyl-1,2,4-triazole, 4-amino-3-mercapto-1,2,4,-triazole, 3-mercapto-1,5-diphenyl-1,2,4-triazole, and 5-(p-aminophenyl)-3-mercapto-1,2,4-triazole.

Other useful initiator compositions include one or more azine compounds as described for example in U.S. Pat. No. 6,936,384 (Munnelly et al.). These compounds are organic heterocyclic compounds containing a 6-membered ring formed from carbon and nitrogen atoms. Azine compounds include heterocyclic groups such as pyridine, diazine, and triazine groups, as well as polycyclic compounds having a pyridine, diazine, or triazine substituent fused to one or more aromatic rings such as carbocyclic aromatic rings. Thus, the azine compounds include, for example, compounds having a quinoline, isoquinoline, benzodiazine, or naphthodiazine substituent. Both monocyclic and polycyclic azine compounds are useful.

Useful azine compounds are triazine compounds that include a 6-membered ring containing 3 carbon atoms and 3 nitrogen atoms such as those described in U.S. Pat. No. 6,309,792 (Hauck et al.), U.S. Pat. No. 6.010,824 (Komano et al.), U.S. Pat. No. 5,885,746 (Iwai et al), U.S. Pat. No. 5,496,903 (Watanabe et al.), and U.S. Pat. No. 5,219,709 (Nagasaka et al.).

The azinium form of azine compounds can also be used if desired. In azinium compounds, a quaternizing substituent of a nitrogen atom in the azine ring is capable of being released as a free radical. The alkoxy substituent that quaternizes a ring nitrogen atom of the azinium nucleus can be selected from among a variety of alkoxy substituents.

Halomethyl-substituted triazines, such as trihalomethyl triazines, are useful in the initiator composition. Representative compounds of this type include but are not limited to, 1,3,5-triazine derivatives such as those having 1 to 3 -CX₃ groups wherein X independently represent chlorine or bromine atoms, including polyhalomethyl-substituted triazines and other triazines, such as 2,4-trichloromethyl-6-methoxyphenyl triazine, 2-phenyl-4,6-bis(trichloromethyl)-s-triazine, 2,4,6-tris(trichloromethyl)-s-triazine, 2-methyl-4,6-bis(trichloromethyl)-s-triazine, 2-(styryl-4,6-bis(trichloromethyl)-s-triazine, 2-(p-methoxystyryl)-4,6-bis(trichloromethyl)-s-triazine, 2-(4-methoxy-naphtho-1-yl)-4,6-bis(trichloromethyl)-s-triazine, 2-(4-ethoxynaphtho-1-yl)-4,6-bis(trichloromethyl)-s-triazine, and 2-(4-(2-ethoxyethyl)-naphtho-1-yl)-4,6-bis(trichloromethyl)-s-triazine], 2-(4-methylthiophenyl)-4,6-bis(trichloromethyl)-2-triazine, 2-(4-chlorophenyl-4,6-bis(trichloromethyl)-2-triazine, 2,4,6-tri(trichloromethyl)-2-triazine, and 2,4,6-tri(tribromomethyl)-2-triazine.

The azine compounds may be used alone or in combination with one or more co-initiators such as titanocenes, mono- and polycarboxylic acids, hexaarylbisimidazoles, as described for example in U.S. Pat. No. 4,997,745 (Kawamura et al.).

Thus, several initiator/co-initiator combinations can be used in various embodiments of the present invention, including but not limited to:
a) a triazine as described above in combination with a co-initiator that is an N-aryl, S-aryl, or O-aryl polycarboxylic acids with at least 2 carboxy groups of which at least one is bonded to the nitrogen, oxygen, or sulfur atom of the aryl moiety (such as aniline diacetic acid and derivatives thereof) as described above,
b) a boron-containing counterion that comprises four of the same or different alkyl or aryl groups, or any combination thereof, wherein the boron-containing counterion is a counterion for an infrared radiation absorbing dye, or is a counterion in an onium salt,
c) a triazine as described above in combination with a co-initiator that is a mercaptan derivative as described above,
d) an iodonium salt (such as an iodonium borate) as described above in combination with a co-initiator that is a metallocene (for example a titanocene or ferrocene) as described for example in U.S. Pat. No. 6,936,384 (noted above),
e) an iodonium salt (such as an iodonium borate) as described above in combination with a co-initiator that is a mercaptotriazole as described above, and
f) a triazine as described above in combination with an alkyl triarylborate or a tetraarylborate.

Examples of other useful initiator compositions are described for example in EP 1,182,033 (Fujimaki et al.) and in U.S. Pat. No. 6,352,812 (Shimazu et al.) and U.S. Pat. No. 6,893,797 (Munnelly et al.).

The free radical generating compounds in the initiator composition are generally present in the radiation-sensitive composition in an amount of at least 0.5% and up to and including 30%, and typically at least 2 and up to and including about 20%, based on composition total solids or total dry weight of the imageable layer. The optimum amount of the various initiator components may differ for various compounds and the sensitivity of the radiation-sensitive composition that is desired and would be readily apparent to one skilled in the art.

A variety of secondary polymeric binders can be used in the radiation-sensitive composition, including those known in the art for use in negative-working radiation-sensitive compositions. These secondary polymeric binders generally have a molecular weight of at least 2,000 and up to and including 1,000,000, at least 10,000 and up to and including 200,000, or at least 10,000 and up to and including 100,000. The acid value (mg KOH/g) of the polymeric binder is generally from about 0 and up to and including 400, at least 0 and up to and including 200, or at least 0 and up to and including 130, as determined using known methods.

The secondary polymeric binder may be present in an amount of from about 1.5 to about 50 weight % based on the total solids content of the radiation-sensitive composition, or the dry coated weight of the imageable layer, and it may comprise from about 30 to about 60 weight % of the dry weight of all polymeric binders.

The secondary polymeric binders may be homogenous, that is, dissolved in the coating solvent, or may exist as discrete particles. Such secondary polymeric binders include but are not limited to, (meth)acrylic acid and acid ester resins [such as (meth)acrylates], polyvinyl acetals, phenolic resins, polymers derived from styrene, N-substituted cyclic imides or maleic anhydrides, such as those described in EP 1,182,033 (Fujimaki et al.) and U.S. Pat. No. 6,309,792 (Hauck et al.), U.S. Pat. No. 6,352,812 (Shimazu et al.), U.S. Pat. No. 6,569,603 (Furukawa et al.), and U.S. Pat. No. 6,893,797 (Munnelly et al.). Also useful are the vinyl carbazole polymers described in copending and commonly assigned U.S. Ser. No. 11/356,518 (filed Feb. 17, 2006 by Tao et al.), and the polymers having pendant vinyl groups as described in copending and commonly assigned U.S. Ser. No. 11/349,376 (filed Feb. 7, 2006 by Tao et al.), both incorporated herein by reference. Copolymers of polyethylene glycol methacrylate/acrylonitrile/styrene in particulate form, dissolved copolymers derived from carboxyphenyl methacrylamide/acrylonitrile/methacrylamide/N-phenyl maleimide, copolymers derived from polyethylene glycol methacrylate/acrylonitrile/vinylcarbazole/-styrene/methylacrylic acid, copolymers derived from N-phenyl maleimide/methacrylamide/methacrylic acid, copolymers derived from urethane-acrylic intermediate A (the reaction product of p-toluene sulfonyl isocyanate and hydroxyl ethyl methacrylate)/acrylonitrile/N-phenyl maleimide, and copolymers derived from N-methoxymethyl methacrylamide/methacrylic acid/acrylonitrile/n-phenylmaleimide are useful.

Other useful secondary polymeric binders in the radiation-sensitive composition (and imageable elements described below) designed for on-press development are those having poly(alkylene glycol) side chains directly or indirectly linked to the polymeric backbone. Many of such polymeric binders are dispersible, developable, or soluble in water or water/solvent mixtures such as fountain solutions or mixtures of fountain solutions and lithographic printing inks. Such polymeric binders include polymeric emulsions, dispersions, or polymers having the pendant poly(alkylene glycol) side chains. Such polymeric binders are described in more detail in for example, U.S. Pat. Nos. 6,582,882 and 6,899,994 (both noted above) and U.S. Patent Application Publication 2005/0003285 (Hayashi et al.). In some instances, these polymeric binders are present in the imageable layer at least partially and possibly entirely, as discrete particles.

In some embodiments, a secondary polymeric binder is an acrylic-urethane hybrid polymer that is commercially available in dispersions from Air Products and Chemicals, Inc. (Allentown, Pa.) under the tradename Hybridur®, for example, the Hybridur® 540, 560, 570, 580, 870, and 878 acrylic-urethane hybrid dispersions. Still other secondary polymeric binders are water-insoluble but soluble in conventional alkaline developers. Examples of such polymeric binders include but are not limited to, (meth)acrylic acid and acid ester resins [such as (meth)acrylates], polyvinyl acetals, phenolic resin, polymers derived from styrene, N-substituted cyclic imides or maleic anhydrides, such as those described in EP 1,182,033 (noted above) and U.S. Pat. No. 6,309,792 (noted above), U.S. Pat. No. 6,352,812 (Shimazu et al.), U.S. Pat. No. 6,569,603 (noted above), and U.S. Pat. No. 6,893,797 (noted above). Also useful are the vinyl carbazole polymers described in copending and commonly assigned U.S. Ser. No. 11/356,518 (filed Feb. 17, 2006 by Tao et al.) and the polymers having pendant vinyl groups as described in copending and commonly assigned Ser. No. 11/349,376 (filed Feb. 7, 2006 by Tao et al.), both of which are incorporated herein by reference.

Thus, in some embodiments, the radiation-sensitive composition (and imageable layer) further comprises:
a) a secondary free radically polymerizable component containing free radically polymerizable groups that is not the primary polymeric binder,
b) a secondary polymeric binder, or
both a) and b).

The radiation-sensitive composition generally includes one or more radiation absorbing compounds, or sensitizers, that absorb imaging radiation, or sensitize the composition to imaging radiation having a λₘₐₓ of from the UV to the IR region of the electromagnetic spectrum, that is, at least 150 nm and up to and including 1500 nm. Some sensitizers can be used at any wavelength, but most sensitizers are optimally useful within certain wavelength ranges. For example, some sensitizers are optimal for use at an exposing wavelength of at least 150 nm and up to and including 650 nm (UV to visible). Other sensitizers are particularly optimal for use for exposure to UV radiation of at least 150 nm and up to and including 475 nm, while still others are optimal for use at an exposure wavelength of at least 650 nm and up to and including 1500 nm (near IR and IR).

Typical UV radiation-sensitive free-radical generating compounds are described above. In some other embodiments, the radiation sensitive compositions are sensitized to “violet” radiation in the range of at least 375 nm and up to and including 475 nm. Useful sensitizers for such compositions include certain pyrilium and thiopyrilium dyes and 3-ketocoumarins. Other useful sensitizers are described for example, in U.S. Pat. No. 6,908,726 (Korionoff et al.) and U.S. Pat. No. 5,227,279 (Kawabata), WO 2004/074929 (Baumann et al.), and U.S. Patent Application Publications 2006/0063101 and 2006/0234155 (both Baumann et al.).

Sensitizers that absorb in the visible region of the electromagnetic spectrum (that is at least 400 nm and up to and including 650 nm) can also be used. Examples of such sensitizers are well known in the art and include the compounds described in Cols. 17-22 of U.S. Pat. No. 6,569,603 (noted above) that is incorporated herein by reference. Other useful visible and UV-sensitive sensitizing compositions include a cyanine dye and a co-initiator (as described above) as described in U.S. Pat. No. 5,368,990 (Kawabata et al.).

Other useful sensitizers for the violet/visible region of sensitization are the 2,4,5-triaryloxazole derivatives as described in WO 2004/074930 (Baumann et al.). These compounds can be used alone or with a co-initiator as described above. Useful 2,4,5-triaryloxazole derivatives can be represented by the Structure G-(Ar₁)₃ wherein Ar₁ is the same or different, substituted or unsubstituted carbocyclic aryl group having 6 to 12 carbon atoms in the ring, and G is a furan, oxazole, or oxadiazole ring. The Ar₁ groups can be substituted with one or more halo, substituted or unsubstituted alkyl, substituted or unsubstituted cycloalkyl, substituted or unsubstituted aryl, amino (primary, secondary, or tertiary), or substituted or unsubstituted alkoxy or aryloxy groups. Thus, the aryl groups can be substituted with one or more R′₁ through R′₃ groups, respectively, that are independently hydrogen or a substituted or unsubstituted alkyl group having from 1 to 20 carbon atoms (such as methyl, ethyl, iso-propyl, n-hexyl, benzyl, and methoxymethyl groups) substituted or unsubstituted carbocyclic aryl group having 6 to 10 carbon atoms in the ring (such as phenyl, naphthyl, 4-methoxyphenyl, and 3-methylphenyl groups), substituted or unsubstituted cycloalkyl group having 5 to 10 carbon atoms in the ring, a —N(R′₄)(R′₅) group, or a —OR′₆ group wherein R′₄ through R′₆ independently represent substituted or unsubstituted alkyl or aryl groups as defined above. At least one of R′₁ through R′₃ is an —N(R′₄)(R′₅) group wherein R′₄ and R′₅ are the same or different alkyl groups. Useful substituents for each Ar₁ group include the same or different primary, secondary, and tertiary amines.

Still another class of useful violet/visible radiation sensitizers includes compounds represented by the Structure Ar₁-G-Ar₂ wherein Ar₁ and Ar₂ are the same or different substituted or unsubstituted aryl groups having 6 to 12 carbon atoms in the ring, or Ar₂ can be an arylene-G-Ar₁ or arylene-G-Ar₂ group, and G is a furan, ozazole, or oxadiazole ring. Ar₁ is the same as defined above, and Ar₂ can be the same or different aryl group as Ar₁. “Arylene” can be any of the aryl groups defined for Ar₁ but with a hydrogen atom removed to render them divalent in nature.

Additional useful “violet”-visible radiation sensitizers are the compounds described in WO 2004/074929 (Baumann et al.). These compounds comprise the same or different aromatic heterocyclic groups connected with a spacer moiety that comprises at least one carbon-carbon double bond that is conjugated to the aromatic heterocyclic groups, and are represented in more detail by Formula (I) of the noted publication.

In embodiments of this invention that are sensitive to infrared radiation, the radiation-sensitive compositions can comprise an infrared radiation absorbing compound (“IR absorbing compounds”) that absorbs radiation of at least 700 nm and up to and including 1400 nm and typically of at least 700 nm and up to and including about 1200 nm. For imageable elements designed for on-press development, it is particularly useful for such IR absorbing compounds to be used in combination with onium salts to enhance polymerization of the polymerizable component and to produce a more durable printing plate.

Useful IR-sensitive radiation absorbing compounds include carbon blacks and other IR-absorbing pigments and various IR-sensitive dyes (“IR dyes”). Examples of suitable IR dyes include but are not limited to, azo dyes, squarilium dyes, croconate dyes, triarylamine dyes, thioazolium dyes, indolium dyes, oxonol dyes, oxaxolium dyes, cyanine dyes, merocyanine dyes, phthalocyanine dyes, indocyanine dyes, indotricarbocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo) polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, squarine dyes, oxazole dyes, croconine dyes, porphyrin dyes, and any substituted or ionic form of the preceding dye classes. Suitable dyes are also described in U.S. Pat. No. 5,208,135 (Patel et al.), U.S. Pat. No. 6,153,356 (Urano et al.), U.S. Pat. No. 6,264,920 (Achilefu et al.), U.S. Pat. No. 6,309,792 (Hauck et al.), and U.S. Pat. No. 6,787,281 (Tao et al.), and EP 1,182,033A2 (noted above).

A general description of one class of suitable cyanine dyes is shown by the formula in paragraph [0026] of WO 2004/101280 (Munnelly et al.), incorporated herein by reference, and a useful IR absorbing compounds is identified below with the Examples.

In addition to low molecular weight IR-absorbing dyes, IR dye moieties bonded to polymers can be used as well. Moreover, IR dye cations can be used as well, that is, the cation is the IR absorbing portion of the dye salt that ionically interacts with a polymer comprising carboxy, sulfo, phospho, or phosphono groups in the side chains.

Useful IR dyes include but are not limited to, the following compounds:

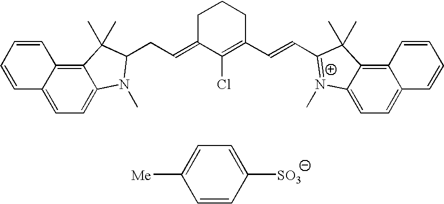

Same as above but with C₃F₇CO₂⁻ as the anion.

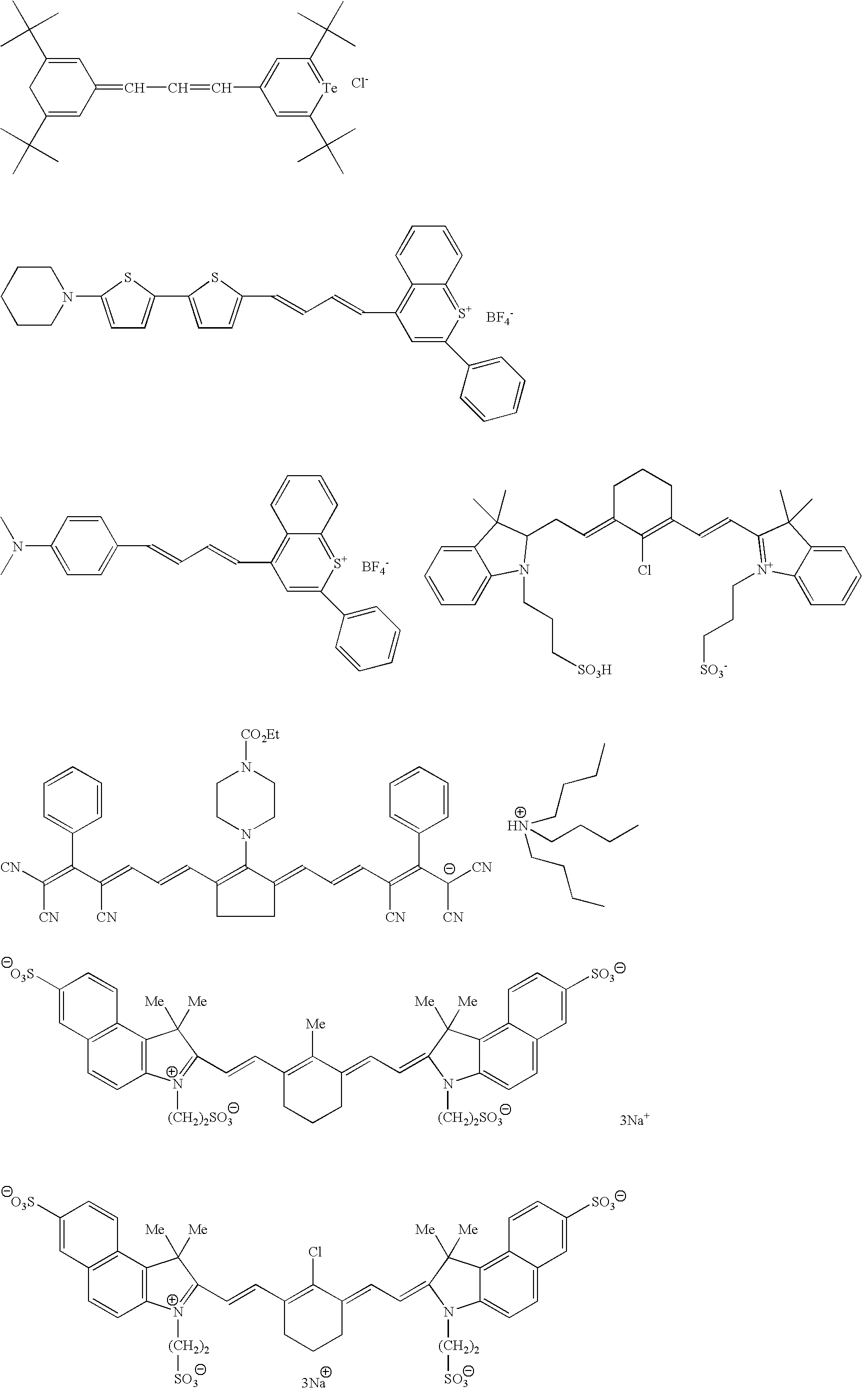

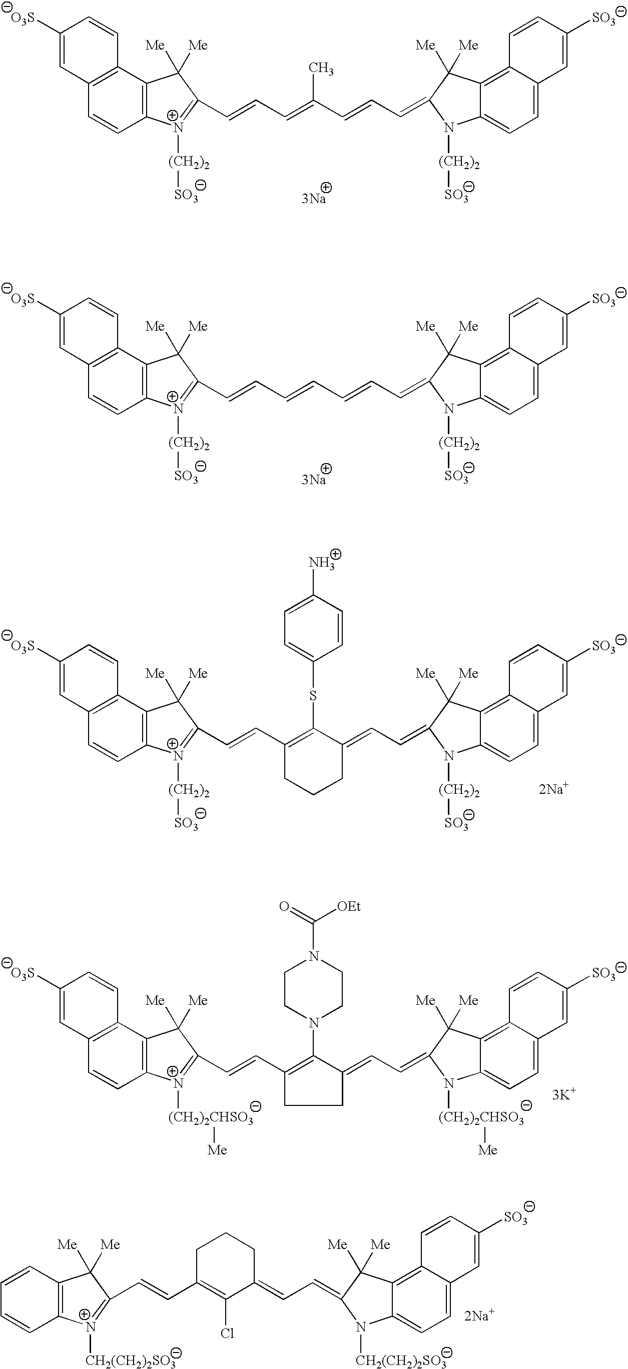

Near infrared absorbing cyanine dyes are also useful and are described for example in U.S. Pat. No. 6,309,792 (Hauck et al.), U.S. Pat. No. 6,264,920 (Achilefu et al.), U.S. Pat. No. 6,153,356 (Urano et al.), U.S. Pat. No. 5,496,903 (Watanate et al.). Suitable dyes may be formed using conventional methods and starting materials or obtained from various commercial sources including American Dye Source (Baie D'Urfe, Quebec, Canada) and FEW Chemicals (Germany). Other useful dyes for near infrared diode laser beams are described, for example, in U.S Pat. No. 4,973,572 (DeBoer).

Useful IR absorbing compounds include carbon blacks including carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET® 200 or CAB-O-JET® 300 (manufactured by the Cabot Corporation) are also useful.

Some useful infrared radiation absorbing dyes have a tetraaryl pentadiene chromophore. Such chromophore generally includes a pentadiene linking group having 5 carbon atoms in the chain, to which are attached two substituted or unsubstituted aryl groups at each end of the linking group. The pentadiene linking group can also be substituted with one or more substituents in place of the hydrogen atoms, or two or more hydrogen atoms can be replaced with atoms to form a ring in the linking group as long as there are alternative carbon-carbon single bonds and carbon-carbon double bonds in the chain.

For example, representative useful IR-sensitive dyes of this type can be defined by the following Structure DYE-I:

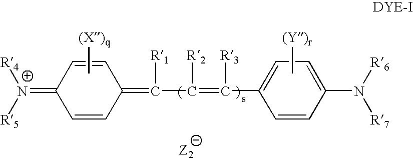

wherein R₁′, R₂′, and R₃′ each independently represents hydrogen, or a halo, cyano, substituted or unsubstituted alkoxy (having 1 to 8 carbon atoms, both linear and branched alkoxy groups), substituted or unsubstituted aryloxy (having 6 to 10 carbon atoms in the carbocyclic ring), substituted or unsubstituted acyloxy (having 2 to 6 carbon atoms), carbamoyl, substituted or unsubstituted acyl, substituted or unsubstituted acylamido, substituted or unsubstituted alkylamino (having at least one carbon atom), substituted or unsubstituted carbocyclic aryl groups (having 6 to 10 carbon atoms in the aromatic ring, such as phenyl and naphthyl groups), substituted or unsubstituted alkyl groups (having 1 to 8 carbon atoms, both linear and branched isomers), substituted or unsubstituted arylamino, or substituted or unsubstituted heteroaryl (having at least 5 carbon and heteroatoms in the ring) group. Alternatively, any two of R₁′, R₂′, and R₃′ groups may be joined together or with an adjacent aromatic ring to complete a 5- to 7-membered substituted or unsubstituted carbocyclic or heterocyclic ring.

For example, R₁′, R₂′, and R₃′ are independently hydrogen, a substituted or unsubstituted carbocyclic aryl group, and a substituted or unsubstituted heteroaryl group.

R₄′, R₅′, R₆′, and R₇′ each independently represents hydrogen, a substituted or unsubstituted alkyl group (having 1 to 10 carbon atoms), a substituted or unsubstituted cycloalkyl group (having from 4 to 6 carbon atoms in the ring), a substituted or unsubstituted aryl group (having at least 6 carbon atoms in the ring), or a substituted or unsubstituted heteroaryl group (having 5 to 10 carbon and heteroatoms in the ring).

Alternatively, R₄′ and R₅′ or R₆′ and R₇′ can be joined together to form a substituted or unsubstituted 5- to 9-membered heterocyclic ring, or R₄′, R₅′, R₆′, or R₇′ can be joined to the carbon atom of the adjacent aromatic ring at a position ortho to the position of attachment of the anilino nitrogen to form, along with the nitrogen to which they are attached, a substituted or unsubstituted 5- or 6-membered heterocyclic ring.

For example, R₄′, R₅′, R₆′, and R₇′ are independently a substituted or unsubstituted alkyl group, a substituted or unsubstituted cycloalkyl group, a substituted or unsubstituted aryl group, or R₄′ and R₅′ or R₆′ and R₇′ can be joined together to form a substituted or unsubstituted 5- to 7-membered heterocyclic ring. Also, they can be independently substituted or unsubstituted alkyl groups of 1 to 8 carbon atoms, substituted or unsubstituted phenyl groups, or R₄′ and R₅′ or R₆′and R₇′ can be joined together to form a substituted or unsubstituted 5- to 7-membered heteroaryl group.

In the DYE I structure, s is 2, Z₂ is a monovalent anion, X″ and Y″ are each independently R₁′ or the atoms necessary to complete a substituted or unsubstituted 5- to 7-membered fused carbocyclic or heterocyclic ring, and q and r are independently integers from 1 to 4.

For example, X″ and Y″ are independently hydrogen or the carbon and heteroatoms needed to provide a fused aryl or heteroaryl ring.

Further details of such bis(aminoaryl)pentadiene IR dyes are provided, including representative IR dyes identified as DYE 1 through DYE 17, DYE 19, and DYE 20, in U.S. Pat. No. 6,623,908 (Zheng et al.) that is incorporated herein by reference for this IR dye description and representative compounds.

In addition, other useful IR-sensitive dyes can also be represented by the following Structure DYE-II:

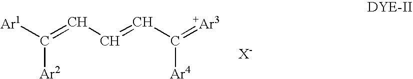

wherein Ar¹ through Ar⁴ are the same or different substituted or unsubstituted aryl groups having at least carbon atoms in the aromatic ring (such as phenyl, naphthyl, and anthryl, or other aromatic fused ring systems) wherein 1 to 3 of the aryl groups are substituted with the same or different tertiary amino group (such as in the 4-position of a phenyl group). Typically two of the aryl groups are substituted with the same or different tertiary amino group, and usually at different ends of the polymethine chain (that is, molecule). For example, Ar¹ or Ar² and Ar3 or Ar⁴ bear the tertiary amine groups. Representative amino groups include but are not limited to those substituted with substituted or unsubstituted alkyl groups having up to 10 carbon atoms or aryl groups such as dialkylamino groups (such as dimethylamino and diethylamino), diarylamino groups (such as diphenylamino), alkylarylamino groups (such as N-methylanilino), and heterocyclic groups such as pyrrolidino, morpholino, and piperidino groups. The tertiary amino group can form part of a fused ring such that one or more of Ar¹ through Ar⁴ can represent a julolidine group.

Besides the noted tertiary groups noted above, the aryl groups can be substituted with one or more substituted or unsubstituted alkyl groups having 1 to 10 carbon atoms, halo atoms (such as chloro or bromo), hydroxyl groups, thioether groups, and substituted or unsubstituted alkoxy groups having 1 to 10 carbon atoms. Substituents that contribute electron density to the conjugated system are useful. While they are not specifically shown in Structure (DYE-II), substituents or fused rings may also exist on (or as part of) the conjugated chain connecting the aryl groups.

In Structure (DYE-II), X⁻ is a suitable counterion that may be derived from a strong acid, and include such anions as ClO₄⁻, BF₄⁻, CF₃SO₃⁻, PF₆⁻, AsF₆⁻, SbF₆⁻, and perfluoroethylcyclohexylsulfonate. Other cations include boron-containing counterions (borates), methylbenzenesulfonic acid, benzenesulfonic acid, methanesulfonic acid, p-hydroxybenzenesulfonic acid, p-chlorobenzenesulfonic acid, and halides.

Two representative IR dyes defined by Structure (DYE-II) are defined as D1 and D2 in WO 98/07574 (Patel et al.) that is incorporated by reference for these dyes and the synthetic method described therein.

Still other useful IR-sensitive dyes are represented by the following Structure (DYE-III):

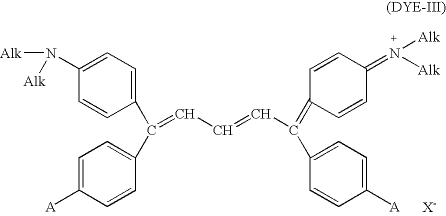

wherein “Alk” represents the same or different substituted or unsubstituted alkyl groups having 1 to 7 carbon atoms (such as substituted or unsubstituted methyl, ethyl, iso-propyl, t-butyl, n-hexyl, and benzyl), and “A” represents hydrogen or the same or different substituted or unsubstituted lower alkyl group having 1 to 3 carbon atoms (such as methyl, ethyl, n-propyl, and iso-propyl), or the same or different dialkylamino groups similar to those defined above for Structure (DYE-2), wherein such groups have the same or different alkyl groups. X⁻ is a suitable counterion as defined above for Structure (DYE-II).

Some embodiments of this invention include a borate anion, such as a tetra-substituted borate anion, which substituents can be the same or different alkyl (having 1 to 20 carbon atoms) or aryl groups (phenyl or naphthyl groups), which groups can be further substituted if desired. Particularly useful boron-containing counterions of this type include alkyltriarylborates, dialkyldiarylborates, and tetraarylborates. Examples of these boron-containing counterions are described for example, in EP 438,123A2 (Murofushi et al.).

Representative useful dyes of this type are described as Dyes 2, 3-A, 3-B, 3-C, 12, and 22 described in EP 438,123A2 (noted above) Useful infrared radiation absorbing dyes can be obtained from a number of commercial sources including Showa Denko (Japan) or they can be prepared using known starting materials and procedures. For example, IR dyes represented by Structure (DYE -I) can be prepared using the synthetic method illustrated in U.S. Pat. No. 6,623,908 (noted above) just before the examples, and IR dyes represented by Structures (DYE-TI) and (DYE-TII) can be prepared using the synthetic procedure described on page 10 (lines 11-14) of WO 98/07574 (noted above).

The infrared radiation absorbing compound (or sensitizer) can be present in the radiation-sensitive composition in an amount generally of at least 1% and up to and including 30% and typically at least 2 and up to and including 15%, based on total solids in the composition, that also corresponds to the total dry weight of the imageable layer. The particular amount needed for this purpose would be readily apparent to one skilled in the art, depending upon the specific compound used.

The radiation-sensitive composition can further comprises one or more nonionic phosphate acrylates, each of which has a molecular weight generally greater than 250 and typically at least 300 and up to and including 1000. By “nonionic” we mean that the phosphate acrylates not only are neutral in charge but they have no internal positive or negative charges. Thus, they are not internal salts or salts formed with an external cation or anion. Moreover, by “phosphate acrylate” we also meant to include “phosphate methacrylates” and other derivatives having substituents on the vinyl group in the acrylate moiety.

Each phosphate moiety may be connected to an acrylate moiety by an alkyleneoxy chain, that is a -(alkylene-O)ₘ— chain composed of at least one alkyleneoxy unit, in which the alkylene moiety has 2 to 6 carbon atoms and can be either linear or branched and m is 1 to 10. For example, the alkyleneoxy chain can comprise ethyleneoxy units, and m is from 2 to 8 or m is from 3 to 6. The alkyleneoxy chains in a specific compound can be the same or different in length and have the same or different alkylene group.

Representative nonionic phosphate acrylates can be represented by the following Structure (I):

P(═O)(OH)ₙ(R)₃₋ₙ (I)

wherein the R groups are independently the same or different groups represented by the following Structure (II):

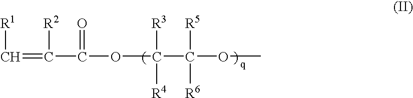

wherein R¹ and R² are independently hydrogen, or a halo group (such as fluoro, chloro, bromo, or iodo) or a substituted or unsubstituted alkyl group having 1 to 4 carbon atoms (such as methyl, chloromethyl, ethyl, isopropyl, n-butyl, and t-butyl). For example, R¹ and R² are independently hydrogen, methyl, or chloro, and typically, they are independently hydrogen or methyl.

R³ through R⁶ are independently hydrogen or a substituted or unsubstituted alkyl group having 1 to 5 carbon atoms (such as methyl, chloromethyl, hydroxymethyl, ethyl, iso-propyl, n-butyl, t-butyl, and n-pentyl). For example, R³ through R⁶ are independently hydrogen or substituted or unsubstituted methyl or ethyl groups, and typically, they are independently hydrogen or unsubstituted methyl groups.

Also, in Structure I, n is 1 or 2.

In Structure II, q is 1 to 10, or from 2 to 8, for example from 3 to 6.

Representative nonionic phosphate acrylates useful in this invention include but are not limited to, ethylene glycol methacrylate phosphate (available from Aldrich Chemical Co.), a phosphate of 2-hydroxyethyl methacrylate that is available as Kayamer PM-2 from Nippon Kayaku (Japan) that is shown below, a phosphate of caprolactone modified 2-hydroxyethyl methacrylate that is available as Kayamer PM-21 (Nippon Kayaku, Japan) that is also shown below, and an ethylene glycol methacrylate phosphate with 4-5 ethoxy groups that is available as Phosmer PE from Uni-Chemical Co., Ltd. (Japan) that is also shown below. Other useful nonionic phosphate acrylates are also shown below.

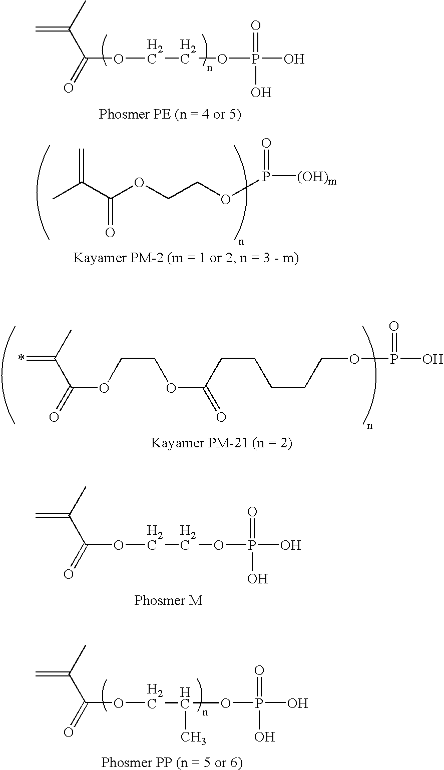

The nonionic phosphate acrylate can be present in the radiation-sensitive composition in an amount of at least 0.6 and up to and including 20% and typically at least 0.9 and up to and including 10%, by weight of the total solids. In the dry imageable layers of the imageable elements, the amount of nonionic phosphate acrylate is present in an amount of at least 8 mg/m² and up to and including 300 mg/m² and typically at least 10 and up to and including about 150 mg/m².

The nonionic phosphate acrylates useful in this invention can be prepared using known reaction conditions and starting materials and several of them are available from commercial sources.

The radiation-sensitive composition can also include a “primary additive” that is a poly(alkylene glycol) or an ether or ester thereof that has a molecular weight of at least 200 and up to and including 4000. This primary additive is present in an amount of at least 2 and up to and including 50 weight %, based on the total solids content of the composition, or the total dry weight of the imageable layer. Particularly useful primary additives include, but are not limited to, one or more of polyethylene glycol, polypropylene glycol, polyethylene glycol methyl ether, polyethylene glycol dimethyl ether, polyethylene glycol monoethyl ether, polyethylene glycol diacrylate, ethoxylated bisphenol A di(meth)acrylate, and polyethylene glycol mono methacrylate. Also useful are SR9036 (ethoxylated (30) bisphenol A dimethacrylate), CD9038 (ethoxylated (30) bisphenol A diacrylate), and SR494 (ethoxylated (5) pentaerythritol tetraacrylate), and similar compounds all of which that can be obtained from Sartomer Company, Inc. In some embodiments, the primary additive may be “non-reactive” meaning that it does not contain polymerizable vinyl groups.

The radiation-sensitive composition can also include a “secondary additive” that is a poly(vinyl alcohol), a poly(vinyl pyrrolidone), poly(vinyl imidazole), or polyester in an amount of up to and including 20 weight % based on the total solids content of the composition, or the total dry weight of the imageable layer.

The radiation-sensitive composition can also include a variety of optional compounds including but not limited to, dispersing agents, humectants, biocides, plasticizers, surfactants for coatability or other properties, viscosity builders, dyes or colorants to allow visualization of the written image (such as crystal violet, methyl violet, ethyl violet, Victoria blue, malachite green, and brilliant green), pH adjusters, drying agents, defoamers, preservatives, antioxidants, development aids, rheology modifiers or combinations thereof, or any other addenda commonly used in the lithographic art, in conventional amounts. Useful viscosity builders include hydroxypropyl cellulose, hydroxyethyl cellulose, carboxymethyl cellulose, and poly(vinyl pyrrolidones).

As examples of useful antioxidants, which may act to extend shelf-life of the imageable element, are compounds that prevent oxidation of the polymeric binder(s) or infrared radiation absorbing dyes including but not limited to, phosphorus-containing antioxidants, sulfur-based antioxidants, amine-containing antioxidants, and phenol-containing antioxidants. Examples of such antioxidants and useful amounts are described in [0051]-[0060] of U.S. Patent Application Publication 2003/0031951 (Aburano), which antioxidant disclosure is incorporated herein by reference.

### Imageable Elements

The imageable elements can be formed by suitable application of a radiation-sensitive composition as described above to a suitable substrate to form an imageable layer. This substrate can be treated or coated in various ways as described below prior to application of the radiation-sensitive composition to improve hydrophilicity. Typically, there is only a single imageable layer comprising the radiation-sensitive composition. If the substrate has been treated to provide an “interlayer” for improved adhesion or hydrophilicity, the applied radiation-sensitive composition is generally considered the “top” or outermost layer. These interlayers, however, are not considered “imageable layers”.

The element can also include what is conventionally known as an overcoat (such as an oxygen impermeable topcoat) applied to and disposed over the imageable layer for example, as described in WO 99/06890 (Pappas et al.). It may be present particularly for imageable elements designed for imaging exposure in the range of from about 250 to about 450 nm. Such overcoat layers can comprise a water-soluble polymer such as a poly(vinyl alcohol), poly(vinyl pyrrolidone), poly(ethyleneimine), or poly(vinyl imidazole), and mixtures thereof, and generally have a dry coating weight of at least 0. 1 and up to and including 4 g/m² in which the water-soluble polymer(s) comprise at least 90% and up to 100% of the dry weight of the overcoat.

The substrate generally has a hydrophilic surface, or at least a surface that is more hydrophilic than the applied radiation-sensitive composition on the imaging side. The substrate comprises a support that can be composed of any material that is conventionally used to prepare imageable elements such as lithographic printing plates. It is usually in the form of a sheet, film, or foil (or web), and is strong, stable, and flexible and resistant to dimensional change under conditions of use so that color records will register a full-color image. Typically, the support can be any self-supporting material including polymeric films (such as polyester, polyethylene, polycarbonate, cellulose ester polymer, and polystyrene films), glass, ceramics, metal sheets or foils, or stiff papers (including resin-coated and metallized papers), or a lamination of any of these materials (such as a lamination of an aluminum foil onto a polyester film). Metal supports include sheets or foils of aluminum, copper, zinc, titanium, and alloys thereof.

Polymeric film supports may be modified on one or both flat surfaces with a “subbing” layer to enhance hydrophilicity, or paper supports may be similarly coated to enhance planarity. Examples of subbing layer materials include but are not limited to, alkoxysilanes, amino-propyltriethoxysilanes, glycidioxypropyl-triethoxysilanes, and epoxy functional polymers, as well as conventional hydrophilic subbing materials used in silver halide photographic films (such as gelatin and other naturally occurring and synthetic hydrophilic colloids and vinyl polymers including vinylidene chloride copolymers).

One useful substrate is composed of an aluminum support that may be treated using techniques known in the art, including roughening of some type by physical (mechanical) graining, electrochemical graining, or chemical graining, usually followed by acid anodizing. The aluminum support can be roughened by physical or electrochemical graining and then anodized using phosphoric or sulfuric acid and conventional procedures. A useful substrate is an electrochemically grained and sulfuric acid or phosphoric acid anodized aluminum support that provides a hydrophilic surface for lithographic printing.

Sulfuric acid anodization of the aluminum support generally provides an oxide weight (coverage) on the surface of from about 1.5 to about 5 g/m² and more typically from about 3 to about 4.3 g/m². Phosphoric acid anodization generally provides an oxide weight on the surface of from about 1.5 to about 5 g/m² and more typically from about 1 to about 3 g/m². When sulfuric acid is used for anodization, higher oxide weight (at least 3 g/m²) may provide longer press life.

An interlayer may be formed by treatment of the aluminum support with, for example, a silicate, dextrine, calcium zirconium fluoride, hexafluorosilicic acid, poly(vinyl phosphonic acid) (PVPA), vinyl phosphonic acid copolymer, poly[(meth)acrylic acid], or acrylic acid copolymer to increase hydrophilicity. Still further, the aluminum support may be treated with a phosphate solution that may further contain an inorganic fluoride (PF). The aluminum support can be electrochemically-grained, sulfuric acid-anodized, and treated with PVPA or PF using known procedures to improve surface hydrophilicity.

The thickness of the substrate can be varied but should be sufficient to sustain the wear from printing and thin enough to wrap around a printing form. Useful embodiments include a treated aluminum foil having a thickness of at least 100 μm and up to and including 600 μm.

The backside (non-imaging side) of the substrate may be coated with antistatic agents and/or slipping layers or a matte layer to improve handling and “feel” of the imageable element.

The substrate can also be a cylindrical surface having the radiation-sensitive composition applied thereon, and thus be an integral part of the printing press. The use of such imaging cylinders is described for example in U.S. Pat. No. 5,713,287 (Gelbart).

The radiation-sensitive composition can be applied to the substrate as a solution or dispersion in a coating liquid using any suitable equipment and procedure, such as spin coating, knife coating, gravure coating, die coating, slot coating, bar coating, wire rod coating, roller coating, or extrusion hopper coating. The composition can also be applied by spraying onto a suitable support (such as an on-press printing cylinder). Typically, the radiation-sensitive composition is applied as the outermost layer.

Illustrative of such manufacturing methods is mixing the primary polymeric binder, initiator composition, radiation absorbing compound, and any other components of the radiation-sensitive composition in a suitable organic solvent [such as methyl ethyl ketone (2-butanone), methanol, ethanol, 1-methoxy-2-propanol, iso-propyl alcohol, acetone, y-butyrolactone, n-propanol, tetrahydrofuran, and others readily known in the art, as well as mixtures thereof], applying the resulting solution to a substrate, and removing the solvent(s) by evaporation under suitable drying conditions. Some representative coating solvents and imageable layer formulations are described in the Examples below. After proper drying, the coating weight of the imageable layer is generally at least 0.1 and up to and including 5 g/m² or at least 0.5 and up to and including 3.5 g/m². The particulate primary polymeric binders present in the imageable layer may partially coalesce or be deformed during the drying operation.

Layers can also be present under the imageable layer to enhance developability or to act as a thermal insulating layer. The underlying layer should be soluble or at least dispersible in the developer and typically have a relatively low thermal conductivity coefficient.

The various layers may be applied by conventional extrusion coating methods from melt mixtures of the respective layer compositions. Typically such melt mixtures contain no volatile organic solvents.

Intermediate drying steps may be used between applications of the various layer formulations to remove solvent(s) before coating other formulations. Drying steps at conventional times and temperatures may also help in preventing the mixing of the various layers.

Once the various layers have been applied and dried on the substrate, the imageable element can be enclosed in water-impermeable material that substantially inhibits the transfer of moisture to and from the imageable element.

By “enclosed”, we mean that the imageable element is wrapped, encased, enveloped, or contained in a manner such that both upper and lower surfaces and all edges are within the water-impermeable sheet material. Thus, none of the imageable element is exposed to the environment once it is enclosed.

Useful water-impermeable sheet materials include but are not limited to, plastic films, metal foils, and waterproof papers that are usually in sheet-form and sufficiently flexible to conform closely to the shape of the imageable element (or stack thereof as noted below) including an irregularities in the surfaces. Typically, the water-impermeable sheet material is in close contact with the imageable element (or stack thereof). In addition, it is preferred that this material is sufficiently tight or is sealed, or both, so as to provide a sufficient barrier to the movement or transfer of moisture to or from the imageable element. Useful water-impermeable materials include plastic films such as films composed of low density polyethylene, polypropylene, and poly(ethylene terephthalate), metallic foils such as foils of aluminum, and waterproof papers such as papers coated with polymeric resins or laminated with metal foils (such as paper backed aluminum foil). The plastic films and metallic foils are most preferred. In addition, the edges of the water-impermeable sheet materials can be folded over the edges of the imageable elements and sealed with suitable sealing means such as sealing tape and adhesives.

The transfer of moisture from and to the imageable element is “substantially inhibited”, meaning that over a 24-hour period, the imageable element neither loses nor gains no more than 0.01 g of water per m². The imageable element (or stack) can be enclosed or wrapped while under vacuum to remove most of the air and moisture. In addition to or instead of vacuum, the environment (for example, humidity) of the imageable element can be controlled (for example to a relative humidity of less than 20%), and a desiccant can be associated with the imageable element (or stack).

For example, the imageable element can be enclosed with the water-impermeable sheet material as part of a stack of imageable elements, which stack contains at least 5 imageable elements and more generally at least 100 or at least 500 imageable elements that are enclosed together. It may be desirable to use “dummy”, “reject”, or non-photosensitive elements at the top and bottom of the stack improve the wrapping. Alternatively, the imageable element can be enclosed in the form of a coil that can be cut into individual elements at a later time. Generally, such a coil has at least 1000 m² of imageable surface, and commonly at least 3000 m2 of imageable surface.

Adjacent imageable elements in the stacks or adjacent spirals of the coil may be separated by interleaving material, for example interleaving paper or tissue (“interleaf paper”) that may be sized or coated with waxes or resin (such as polyethylene) or inorganic particles. Many useful interleaving materials are commercially available. They generally have a moisture content of less than 8% or typically less than 6%.

### Imaging Conditions

During use, the imageable element is exposed to a suitable source of imaging or exposing radiation such as UV, visible light, near-infrared, or infrared radiation, depending upon the radiation absorbing compound present in the radiation-sensitive composition, at a wavelength of from about 150 to about 1500 nm. In some embodiments, imaging is carried out using a source of UV or “violet” imaging or exposing radiation at from at least 150 nm and up to and including 475 nm and typically at least 200 nm and up to and including 450 nm. For example, imaging can be carried out using imaging or exposing radiation, such as from an infrared laser at a wavelength of at least 700 nm and up to and including about 1400 nm and typically at least 700 nm and up to and including 1200 nm. Imaging can be carried out using imaging radiation at multiple wavelengths at the same time if desired.

The laser used to expose the imageable element is usually a diode laser, because of the reliability and low maintenance of diode laser systems, but other lasers such as gas or solid-state lasers may also be used. The combination of power, intensity and exposure time for laser imaging would be readily apparent to one skilled in the art. Presently, high performance lasers or laser diodes used in commercially available imagesetters emit infrared radiation at a wavelength of at least 800 nm and up to and including 850 nm or at least 1060 and up to and including 1120 nm.

The imaging apparatus can function solely as a platesetter or it can be incorporated directly into a lithographic printing press. In the latter case, printing may commence immediately after imaging and development, thereby reducing press set-up time considerably. The imaging apparatus can be configured as a flatbed recorder or as a drum recorder, with the imageable member mounted to the interior or exterior cylindrical surface of the drum. An example of an useful imaging apparatus is available as models of Creo Trendsetter® platesetters available from Eastman Kodak Company (Burnaby, British Columbia, Canada) that contain laser diodes that emit near infrared radiation at a wavelength of about 830 nm. Other suitable imaging sources include the Crescent 42T Platesetter that operates at a wavelength of 1064 nm (available from Gerber Scientific, Chicago, Ill.) and the Screen PlateRite 4300 series or 8600 series platesetter (available from Screen, Chicago, Ill.). Additional useful sources of radiation include direct imaging presses that can be used to image an element while it is attached to the printing plate cylinder. An example of a suitable direct imaging printing press includes the Heidelberg SM74-DI press (available from Heidelberg, Dayton, Ohio).

Imaging with infrared radiation can be carried out generally at imaging energies of at least 30 mJ/cm² and up to and including 500 mJ/cm², and typically at least 50 and up to and including 300 mJ/cm² depending upon the sensitivity of the imageable layer.

Imaging radiation in the UV to visible region of the spectrum, and particularly the UV region (for example at least 150 nm and up to and including 475 nm), can be carried out generally using energies of at least 0.01 mJ/cm² and up to and including 0.5 mJ/cm², and typically at least 0.02 and up to and including about 0.1 mJ/cm². It would be desirable, for example, to image the UV/visible radiation-sensitive imageable elements at a power density in the range of at least 0.5 and up to and including 50 kW/cm² and typically of at least 5 and up to and including 30 kW/cm². Such imaging could be carried out on-press, or the subsequent development could be carried out on-press.

While laser imaging is desired in the practice of this invention, imaging can be provided by any other means that provides thermal energy in an imagewise fashion. For example, imaging can be accomplished using a thermoresistive head (thermal printing head) in what is known as “thermal printing”, described for example in U.S. Pat. No. 5,488,025 (Martin et al.). Thermal print heads are commercially available (for example, a Fujitsu Thermal Head FTP-040 MCSOO1 and TDK Thermal Head F415 HH7-1089).

### Development and Printing

With or without a post-exposure baking step after imaging and before development, the imaged elements can be developed “off-press” using conventional processing and an aqueous alkaline or organic solvent-based developer. Alternatively, the imaged elements can be developed, or imaged and developed, “on-press” as described in more detail below. In most embodiments, a post-exposure baking step can be omitted.

For off-press development, the developer composition commonly includes one or more ingredients selected from the group consisting of surfactants, chelating agents (such as salts of ethylenediaminetetraacetic acid), organic solvents (such as benzyl alcohol), and alkaline components (such as inorganic metasilicates, organic metasilicates, hydroxides, bicarbonates, organic amines, and sodium triphosphates). The pH of the alkaline developer is typically at least 8 and up to and including 14. The imaged elements are generally developed using conventional processing conditions.

Developers commonly used for conventional negative-working elements may be used. Such developers are typically single-phase solutions containing organic solvents that are miscible or dispersible in water, surfactants, alkali agents, and other additives such as chelating agents, antifoamants, and algicides. The pH values of such developers are typically in the range of from about 7 to about 12. Useful organic solvents include the reaction products of phenol with ethylene oxide and propylene oxide [such as ethylene glycol phenyl ether (phenoxyethanol)], benzyl alcohol, esters of mono- di-, or triethylene glycol and of mono-, di-, or tripropylene glycol with acids having 6 or less carbon atoms, and ethers of mono-, di-, or triethylene glycol, diethylene glycol, and of mono-, di-, or tripropylene glycol with alkyl groups having 6 or less carbon atoms, such as 2-ethylethanol and 2-butoxyethanol. The organic solvent(s) is generally present in an amount of from about 0.5 to about 15% based on total developer weight.

Representative developers used for conventional negative-working elements include ND-1 Developer, Developer 980, SP 200 Developer, “2-in-1” Developer, ProNeg D-501 Developer, 955 Developer, and 956 Developer (available from Kodak Polychrome Graphics a subsidiary of Eastman Kodak Company).

Developers commonly used for developing conventional positive-working elements may also be used. Such developers typically contain alkali agents (such as alkali metal silicate or metasilicates, alkali metal hydroxides, alkali metal triphosphates, and alkali metal carbonates), and optional additives such as surfactants, anticorrosion agents, chelating agents, antifoamants, and coating protection agents. Such developers generally have a pH of at least II and typically of at least 13. Useful developers of this type include 3000 Developer, 9000 Developer, GOLDSTAR Developer, GREENSTAR Developer, ThermalPro Developer, PROTHERM Developer, MXi813 Developer, TCD-300 Developer, and MX1710 Developer (all available from Kodak Polychrome Graphics, a subsidiary of Eastman Kodak Company).

Generally, the alkaline developer is applied to the imaged element by rubbing or wiping the outer layer with an applicator containing the developer. Alternatively, the imaged element can be brushed with the developer or the developer may be applied by spraying the outer layer with sufficient force to remove the exposed regions. Still again, the imaged element can be immersed in the developer. In all instances, a developed image is produced in a lithographic printing plate having excellent resistance to press room chemicals.

Following off-press development, the imaged element can be rinsed with water and dried in a suitable fashion. The dried element can also be treated with a conventional gumming solution (such as gum arabic). In addition, a postbake operation can be carried out, with or without a blanket or floodwise exposure to UV or visible radiation. Alternatively, a blanket UV or visible radiation exposure can be carried out, without a postbake operation.

Printing can be carried out by applying a lithographic printing ink and fountain solution to the printing surface of the imaged and developed element. The fountain solution is taken up by the non-imaged regions, that is, the surface of the hydrophilic substrate revealed by the imaging and development steps, and the ink is taken up by the imaged (non-removed) regions of the imaged layer. The ink is then transferred to a suitable receiving material (such as cloth, paper, metal, glass, or plastic) to provide a desired impression of the image thereon. If desired, an intermediate “blanket” roller can be used to transfer the ink from the imaged member to the receiving material. The imaged members can be cleaned between impressions, if desired, using conventional cleaning means.

Some imageable elements of this invention are designed for development “on-press”. This type of development avoids the use of the developing solutions described above. The imaged element is directed mounted on press wherein the unexposed regions in the imageable layer are removed by a suitable fountain solution, lithographic printing ink, or a combination of both, when the initial printed impressions are made. Typical ingredients of aqueous fountain solutions include pH buffers, desensitizing agents, surfactants and wetting agents, humectants, low boiling solvents, biocides, antifoaming agents, and sequestering agents. A representative example of a fountain solution is Varn Litho Etch 142 W+Varn PAR (alcohol sub) (available from Varn International, Addison, Ill.).

The following examples are provided to illustrate the practice of the invention but are by no means intended to limit the invention in any manner.

### EXAMPLES

The components and materials used in the examples and analytical methods used in evaluation were as follows:

Aqua image cleaner/preserver is available from Eastman Kodak Company (Rochester, N.Y.).

Bayhydrol® 124 is a 35% by weight aqueous urethane dispersion that is available from Bayer Material Science (Pittsburgh, Pa.).

Bayhydrol® UV VP LS 2280 is a 39% by weight aqueous urethane acrylate dispersion that is available from Bayer MaterialScience.

Bayhydrol® UV VP LS 2282 is a 39% by weight aqueous urethane acrylate dispersion that is available from Bayer MaterialScience.

Bayhydrol® UV VP LS 2317 is a 37% by weight aqueous urethane acrylate dispersion that is available from Bayer MaterialScience.

Bayhydrol® UV VP LS 2348 is a 40% by weight aqueous urethane acrylate dispersion that is available from Bayer MaterialScience.

Bayhydrol® UV XP 2420 is a 40% by weight aqueous urethane acrylate dispersion that is available from Bayer MaterialScience.

BLO represents γ-butyrolactone.

Byk® 307 is a polyethoxylated dimethyl polysiloxane copolymer that was obtained from Byk Chemie (Wallingford, Conn.) in a 25 weight % xylene/methoxypropyl acetate solution.

CD9051 is a trifunctional acid ester monomer that was obtained from Sartomer Company, Inc. (Exton, Pa.).

Crystal Violet is a triarylmethane dye that was obtained from Spectrum Chemical (Gardena, Calif.).

Elvanol® 5105 is a poly(vinyl alcohol) that was obtained from Dupont (Wilmington, Del.).

FluorN™ 2900 is a fluorosurfactant that was obtained from Cytonix Corporation (Beltsville, Md.).

HB-NK Ester BPE 500 is an ethoxylated Bisphenol A dimethacrylate that was obtained from NK-Esters (Japan).

Hybridur® 580 is a urethane-acrylic hybrid polymer dispersion (40%) that was obtained from Air Products and Chemicals, Inc. (Allentown, Pa.).

IB05 represents bis(4-t-butylphenyl) iodonium tetraphenylborate.

IPA represents iso-propyl alcohol.

IR Dye A represents a cyanine dye that has the following structure:

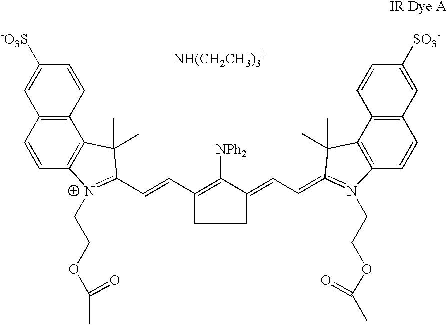

IRT is an IR Dye that was obtained from Showa Denko (Japan) and has the following structure:

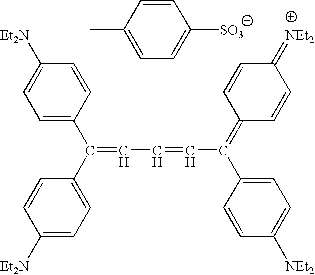

66e represents the IR dye shown as follows that was obtained from FEW Chemicals GmbH (Germany):

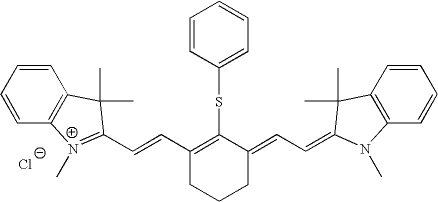

Kayamer PM-2 is a mixed phosphate of 2-hydroxyethyl methacrylate that was obtained from Nippon Kayaku (Japan).

Laromer™ LR 8949 is a 40% aqueous radiation-curable aliphatic polyurethane dispersion that is available from BASF (Ludwigshafen, Germany).

Laromer™ LR 8983 is a 40% aqueous radiation-curable aromatic polyurethane dispersion that is available from BASF.

Laromer™ LR 9005 is a 40% aqueous radiation-curable aromatic polyurethane dispersion that is available from BASF.

Masurf® FS-1520 is a fluoroaliphatic betaine fluorosurfactant that was obtained from Mason Chemical Company (Arlington Heights, Ill.).

MEK represents methyl ethyl ketone.

N-BAMAAm represents benzoic acid methacrylamide or carboxyphenyl methacrylamide.

NK Ester A-DPH is a dipentaerythritol hexaacrylate that was obtained from Kowa American (New York, N.Y.).

Oligomer 1 is a 30% by weight solution in ethyl acetate of a urethane acrylate prepared by reacting 2 parts of hexamethylene diisocyanate, 2 parts of hydroxyethyl methacrylate, and 1 part of 2-(2-hydroxyethyl)piperidine.

Oligomer 2 urethane acrylate was prepared by reacting 1-methyl-2,4-bis-isocyanate benzene with hydroxyethyl acrylate and pentaerythritol triacrylate.

PGME represents 1 -methoxy-2-propanol and it is also known as Dowanol PM.

PF represents a post-treatment with an inorganic monosodium phosphate solution activated by sodium fluoride.

Phosmer PE is an ethylene glycol methacrylate phosphate with 4-5 ethoxy groups that was obtained from Uni-Chemical Co. Ltd. (Japan).

Pigment A is a 22.5% solids dispersion of 7.7 parts of a polyvinyl acetal derived from poly(vinyl alcohol) acetalized with acetaldehyde, butyraldehyde, and 4-formylbenzoic acid, 76.9 parts of Irgalith Blue GLVO (Cu-phthalocyanine C.I. Pigment Blue 15:4) and 15.4 parts of Disperbyk® 167 dispersant (Byk Chemie) in 1-methoxy-2-propanol.

Polymer A is a 37/48/10/5 weight percent copolymer of N-benzoic acid methacrylamide/acrylonitrile/methacrylamide/N-phenyl maleimide.

Polymer B is a 10/70/20 weight percent copolymer emulsion/dispersion of polyethylene glycol methyl ether methacrylate/acrylonitrile/styrene (25%).

Prisco LPC is a liquid plate cleaner that was obtained from Printer's Service (Newark, N.J.).

S0507 is an IR dye that was obtained from FEW Chemicals GmbH (Germany):

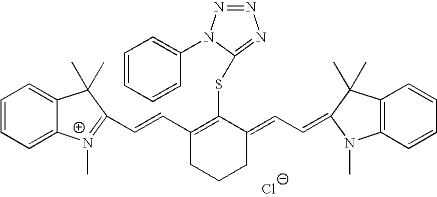

Sartomer 349 is ethoxylated Bisphenol A diacrylate that was obtained from Sartomer Company, Inc. (Exton, Pa.).

Sartomer 399 is dipentaerythritol pentaacrylate that was obtained from Sartomer Company, Inc.

Sartomer 415 is ethoxylated (20) trimethylolpropane triacrylate that was obtained from Sartomer Company, Inc.

Urethane-acrylic intermediate A is a reaction product of p-toluene sulfonyl isocyanate and hydroxyethyl methacrylate.

UV plate cleaner was obtained from Allied Pressroom Chemistry, Inc. (Hollywood, Fla.).

Varn Litho Etch 142 W fountain solution was obtained from Varn International (Addison, Ill.).

Varn-120 plate cleaner was obtained from Varn International.

Varn PAR alcohol replacement was obtained from Varn International.

Zonyl® FSN-100 is a non-ionic fluorosurfactant that was obtained from Dupont (Mississauga, Ontario, Calif.).

The “DH Test” used in the following Examples was a dry-heat accelerated aging test carried out at 48° C. for 5 days.

The “RH Test” used in the following Examples was a high humidity accelerated aging test carried out at 38° C. and a relative humidity of 85% for 5 days.

### Example 1

### Negative-Working Imageable Element and Imaging Method—Two Layers

An imageable layer formulation was prepared by dissolving or dispersing 2.1 g of Bayhydrol® UV VPLS 2317 dispersion, 0.5 g of Sartomer 399, 0.5 g of NK ester A-DPH, 0.1 g of Phosmer PE, 0.2 g of IB-05, 0.07 g of IRT Dye, 0.3 g of Pigment A, and 0.02 g of Zonyl® FSN-100 in 1.5 g of BLO, 10 g of MEK, 2 g of methanol, and 0.5 g of water. The imageable layer formulation was applied to an electrochemically grained and sulfuric acid anodized aluminum substrate that had been post-treated with poly(vinyl phosphoric acid) to provide a dry coating weight of about 1.2 g/m². On each resulting dried imageable layer, a topcoat formulation was applied, comprising 8 g of Elvanol® 5105, 92 g of water, and 0.04 g of Masurf® FS-1520 to provide a dry coating weight of about 0.8 g/m². Both formulations were applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer (Eastman Kodak Company) at 23° C. The minimum energy to achieve a solid image was about 30 mJ/cm². The resulting printing plate passed both the “DH” and “RH” tests without any reduction in plate developability and speed.

### Example 2

### Negative-Working Imageable Element and Imaging Method—Two Layers

An imageable layer formulation was prepared by dissolving or dispersing 2.0 g of Bayhydrol® UV XP 2420 dispersion, 0.25 g of Sartomer 399, 0.25 g of NK ester A-DPH, 0.625 g of Oligomer 2 (80% in MEK), 0.1 g of Phosmer PE, 0.2 g of IB-05, 0.07 g of IRT Dye, 0.03 g of Crystal Violet, and 0.02 g of Zonyl® FSN-100 in 2.5 g of PGME, 1.5 g of BLO, 8 g of MEK, 2 g of methanol, and 0.5 g of water. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 8 g of Elvanol® 5105, 92 g of water, and 0.04 g of Masurf® FS-1520 to provide a dry coating weight of about 0.8 g/m². Both formulations were applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 30 mJ/cm².

### Example 3

### Negative-Working Imageable Element and Imaging Method—Two Layers

An imageable layer formulation was prepared by dissolving or dispersing 2.1 g of Bayhydrol® UV VPLS 2280 dispersion, 0.25 g of Sartomer 399, 0.25 g of NK ester A-DPH, 0.625 g of Oligomer 2 (80% in MEK), 0.1 g of Phosmer PE, 0.2 g of IB-05, 0.07 g of IRT Dye, 0.03 g of Crystal Violet, and 0.02 g of Zonyl® FSN-100 in 2.5 g of PGME, 1.5 g of BLO, 8 g of MEK, 2 g of methanol, and 0.5 g of water. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 8 g of Elvanol® 5105, 92 g of water, and 0.04 g of Masurf® FS-1520 to provide a dry coating weight of about 0.8 g/m². Both formulations were applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 30 mJ/cm².

The developed printing plate was tested on Miehle sheet-fed press using a wear ink containing 1.5% calcium carbonate and fountain solution containing Varn Litho Etch 142 W at 3 oz./gal (23.4 ml/liter) and PAR alcohol replacement at 3 oz./gal (23.4 ml/liter). A chemical resistance test was performed after 5,000 impressions by applying UV plate cleaner and Varn-120 plate cleaner, in different areas to the image of the plate and resuming the printing without any cleaning after 10-15 minutes. At the 90 mJ/cm2 exposure energy, the image recovered after 10 impressions and did not show any degradation from the plate cleaners. At the end of the workday, the printing plate was cleaned with Aqua-image cleaner/preserver and left mounted on the press for one night. Upon start-up the following morning, the printing plate performed identically to the previous evening. At the fully wearing condition, the printing plate did not show any solid wear after 50,000 impressions. This printing plate also passed both “DH” and “RH” tests identified above without any reduction in plate developability and speed.

### Example 4

### Negative-Working Imageable Element and Imaging Method—Two Layers

An imageable layer formulation was prepared by dissolving or dispersing 1.4 g of Bayhydrol® UV VPLS 2317 dispersion, 1.4 g of Hybridur® 580 dispersion, 0.25 g of Sartomer 399, 0.25 g of NK ester A-DPH, 0.625 g of Oligomer 2 (80% in MEK), 0.1 g of Phosmer PE, 0.2 g of IB-05, 0.07 g of IRT Dye, 0.03 g of Crystal Violet, and 0.02 g of Zonyl® FSN-100 in 2.5 g of PGME, 1.5 g of BLO, 8 g of MEK, 2 g of methanol, and 0.5 g of water. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 8 g of Elvanol® 5105, 92 g of water, and 0.04 g of Masurf® FS-1520 to provide a dry coating weight of about 0.8 g/m². Both formulations were applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 30 mJ/cm².

A developed printing plate was tested on Miehle sheet-fed press using a wear ink containing 1.5% calcium carbonate and fountain solution containing Varn Litho Etch 142 W at 3 oz/gal (23.4 ml/liter) and PAR alcohol replacement at 3 oz/gal (23.4 ml/liter). At the fully wearing condition, the printing plate did not show any solid wear after 49,000 impressions at the exposure energy of 90 mJ/cm². This printing plate also passed both “DH” and “RH” tests identified above without any reduction in plate developability and speed.

### Example 5

### Negative-Working Imageable Element and Imaging Method—Two Layers

An imageable layer formulation was prepared by dissolving or dispersing 0.85 g of Bayhydrol® V VPLS 2280 dispersion, 1.1 g of Hybridur® 580 dispersion, 0.5 g of Sartomer 399, 0.5 g of NK ester A-DPH, 0.1 g of Phosmer PE, 0.2 g of IB-05, 0.07 g of IRT Dye, 0.3 g of Pigment A, and 0.02 g of FluorN™ 2900 in 2.5 g of PGME, 1.5 g of BLO, 8 g of MEK, 2 g of methanol, and 0.5 g of water. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 8 g of Elvanol® 5105, 92 g of water, and 0.04 g of Masurf® FS-1520 to provide a dry coating weight of about 0.8 g/m². Both formulations were applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 30 mJ/cm².

A developed printing plate was tested on Miehle sheet-fed press using a wear ink containing 1.5% calcium carbonate and fountain solution containing Varn Litho Etch 142 W at 3 oz/gal (23.4 ml/liter) and PAR alcohol replacement at 3 oz./gal (23.4 ml/liter). A chemical resistance test was performed after 5,000 impressions by applying UV plate cleaner and Varn-120 plate cleaner, in different areas to the image of the plate and resuming the printing without any cleaning after 10-15 minutes. At the 60 and 90 mJ/cm² exposure energies, all of the images recovered after 10-25 impressions and did not show any degradation from the plate cleaners. At the end of the workday, the printing plate was cleaned with Aqua-image cleaner/preserver and left mounted on the press for one night. Upon start-up the following morning, the printing plate performed identically to the previous evening. At the fully wearing condition, the printing plate did not show any solid wear after 47,000 and 49,000 impressions for both 60 and 90 mJ/cm² exposure energies, respectively. This printing plate also passed both “DH” and “RH” tests identified above without any reduction in plate developability and speed.

### Example 6

### Negative-Working Imageable Element and Imaging Method—Two Layers

An imageable layer formulation was prepared by dissolving or dispersing 1.13 g of Bayhydrol® UV VPLS 2280 dispersion, 3.3 g of Polymer A (10% in MEK/PGME/BLO/water at a 5:2: 1:1 ratio, acid number of 98 mg KOH/g), 0.5 g of Sartomer 399, 0.5 g of NK ester A-DPH, 0.1 g of CD9051, 0.18 g of IB-05, 0.05 g of S0507, 0.5 g of Pigment A, and 0.4 g of FluorN™ 2900 (5% in PGME) in 3.5 g of PGME, 1.2 g of BLO, 5.7 g of MEK, 1 g of methanol, and 0.6 g of water. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 4 g of Elvanol® 5105, 4 g of IPA, 92 g of water, and 0.02 g of Masurf® FS-1520 to provide a dry coating weight of about 0.4 g/m². Both formulations were applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 30 mJ/cm². This printing plate also passed both “DH” and “RH” tests identified above without any reduction in plate developability and speed.

### Example 7

### Negative-Working Imageable Element and Imaging Method—One Layer

An imageable layer formulation was prepared by dissolving or dispersing 1.98 g of Bayhydrol® UV VPLS 2280 dispersion, 0.5 g of Sartomer 399, 0.5 g of NK ester A-DPH, 0.1 g of Phosmer PE, 0.18 g of IB-05, 0.05 g of S0507, 0.5 g of Pigment A, and 0.4 g of FluorN™ 2900 (5% in PGME) in 4.5 g of PGME, 1.2 g of BLO, 6.7 g of MEK, 1 g of methanol, and 0.6 g of water. The imageable layer formulation was applied to an electrochemically grained and sulfuric acid anodized aluminum substrate that had been post-treated with poly(vinyl phosphoric acid) to provide a dry coating weight of about 1.2 g/m². The formulation was applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 55 mJ/cm². It did not show any fogging after a 7-hour exposure to white light.

### Example 8

### Negative-Working Imageable Element and Imaging Method—One Layer

An imageable layer formulation was prepared by dissolving or dispersing 1.92 g of Laromer™ LR9005 dispersion, 0.5 g of Sartomer 399, 0.5 g of NK ester A-DPH, 0.1 g of Phomer PE, 0.18 g of IB-05, 0.05 g of S0507, 0.5 g of Pigment A, and 0.4 g of FluorN™ 2900 (5% in PGME) in 4.5 g of PGME, 1.2 g of BLO, 6.7 g of MEK, 1 g of methanol, and 0.6 g of water. The imageable layer formulation was applied to an electrochemically grained and sulfuric acid anodized aluminum substrate that had been post-treated with poly(vinyl phosphoric acid) to provide a dry coating weight of about 1.2 g/m². The formulation was applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 60 mJ/cm².

### Example 9

### Negative-Working Imageable Element and Imaging Method—Two Layers

An imageable layer formulation was prepared by dissolving or dispersing 4.3 g of Bayhydrol® UV VPLS 2280 dispersion, 0.2 g of IB-05, 0.05 g of S0507, 0.5 g of Pigment A, and 0.4 g of FluorN™ 2900 (5% in PGME) in 3.5 g of PGME, 1.2 g of BLO, 5.7 g of MEK, 1 g of methanol, and 0.6 g of water. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 4 g of Elvanol® 5105, 4 g of IPA, 92 g of water, and 0.02 g of Masurf® FS-1520 to provide a dry coating weight of about 0.4 g/m². Both formulations were applied using a wire-wound rod and then dried for approximately 60 seconds in a Ranar conveyor oven set at 120° C.

The resulting imageable element was placed on a CREO Trendsetter® 3244x imagesetter and exposed to an 830 nm IR laser. The imaged element was then developed with 956 Developer at a room temperature. The minimum energy to achieve a solid image was about 100 mJ/cm².

### Example 10

### Negative-Working Imageable Element and Imaging Method—Two Layers

An imageable layer formulation was prepared by dissolving or dispersing 4.6 g of Bayhydrol® UV VPLS 2317 dispersion, 0.2 g of IB-05, 0.07 g of IRT, 0.3 g of Pigment A, and 0.5 g of FluorN™ 2900 (5% in PGME) in 2 g of PGME and 10 g of MEK. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 4 g of Elvanol® 5105, 4 g of IPA, 92 g of water, and 0.02 g of Masurf® FS-1520 to provide a dry coating weight of about 0.4 g/m². Both formulations were applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 30 mJ/cm².

### Example 11

### Negative-Working Imageable Element and Imaging Method—Two Layers

An imageable layer formulation was prepared by dissolving or dispersing 4.2 g of Laromer™ LR9005 dispersion, 0.2 g of IB-05, 0.07 g of IRT, 0.3 g of Pigment A, and 0.5 g of FluorN™ 2900 (5% in PGME) in 2 g of PGME and 10 g of MEK. The imageable layer formulation was applied to an electrochemically grained and sulfuric acid anodized aluminum substrate that had been post-treated with poly(vinyl phosphoric acid) to provide a dry coating weight of about 1.2 g/m². On each resulting imageable layer, a topcoat formulation was applied, comprising 4 g of Elvanol® 5105, 4 g of IPA, 92 g of water, and 0.02 g of Masurf® FS-1520 to provide a dry coating weight of about 0.4 g/m². Both formulations were applied using a wire-wound rod and then dried for approximately 60 seconds in a Ranar conveyor oven set at 120° C.

The resulting imageable element was placed on a CREO Trendsetter® 3244× image setter and exposed to an 830 nm IR laser. The imaged element was then developed in a N34 processor charged with 956 Developer at 23° C. The minimum energy to achieve a solid image was about 40 mJ/cm².

### Example 12

### Negative-Working Imageable Element and Imaging Method—One Layer

An imageable layer formulation was prepared by dissolving or dispersing 4.2 g of Laromer™ LR9005 dispersion, 0.2 g of IB-05, 0.07 g of IRT, 0.3 g of Pigment A, and 0.5 g of FluorN™ 2900 (5% in PGME) in 2 g of PGME and 10 g of MEK. The imageable layer formulation was applied to an electrochemically grained and sulfuric acid anodized aluminum substrate that had been post-treated with poly(vinyl phosphoric acid) to provide a dry coating weight of about 1.2 g/m². The formulation was applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed with 956 Developer at 23° C. The minimum energy to achieve a solid image was about 100 mJ/cm².

### Example 13

### Negative-Working Imageable Element and Imaging Method—One Layer

An imageable layer formulation was prepared by dissolving or dispersing 4.6 g of Bayhydrol® UV VPLS 2317, 0.2 g of IB-05, 0.05 g of S0507, 0.5 g of Pigment A, and 0.4 g of FluorN™ 2900 (5% in PGME) in 3.5 g of PGME, 1.2 g of BLO, 5.7 g of acetone, 1 g of methanol, and 0.6 g of water. The imageable layer formulation was applied to an electrochemically grained and sulfuric acid anodized aluminum substrate that had been post-treated with poly(vinyl phosphoric acid) to provide a dry coating weight of about 1.2 g/m². The formulation was applied using a wire-wound rod and then dried for approximately 60 seconds in a Ranar conveyor oven set at 120° C.

The resulting imageable element was placed on a CREO Trendsetter® 3244× imagesetter and exposed to an 830 nm IR laser. The imaged element was then developed in a N34 processor charged with 956 Developer at 23° C. The minimum energy to achieve a solid image was about 140 mJ/cm².

### Comparative Examples 1 and 2

Two comparative radiation-sensitive compositions outside the scope of this invention were prepared as follows. Neither composition contained a primary polymeric binder as defined above or any other free radically polymerizable component.

A formulation was prepared by dissolving or dispersing 4.2 g of non-UV curable Hybridur® 580 dispersion, 0.2 g of IB-05, 0.05 g of S0507, 0.5 g of Pigment A, and 0.4 g of FluorN™ 2900 (5% in PGME) in 3.5 g of PGME, 1.2 g of BLO, 5.7 g of MEK, 1 g of methanol, and 0.6 g of water. This comparative formulation was applied to an electrochemically grained and sulfuric acid anodized aluminum substrate that had been post-treated with poly(vinyl phosphoric acid) to provide a dry coating weight of about 1.2 g/m². The formulation was applied using a wire-wound rod and then dried for approximately 60 seconds in a Ranar conveyor oven set at 120° C.

For Comparative Example 1, the resulting element was placed on a CREO Trendsetter® 3244× imagesetter and exposed to an 830 nm IR laser. The exposed element was then developed with 956 Developer at 23° C. There was no imaged generated in the exposures of 20 to 200 mJ/cm².

For Comparative Example 2, a topcoat formulation was applied, comprising 4 g of Elvanol® 5105, 4 g of IPA, 92 g of water, and 0.04 g of Masurf® FS-1520 to provide a dry coating weight of about 0.4 g/m², using the same conditions as above. The resulting two-layer element was placed on a CREO Trendsetter® 3244× imagesetter and exposed to an 830 nm IR laser at energies of 20 to 200 mJ/cm². The exposed element was then developed with 956 Developer at 23° C. There was no imaged generated in the exposures of 20 to 200 mJ/cm².

### Comparative Examples 3 and 4

Two other comparative radiation-sensitive compositions outside the scope of this invention were also prepared outside the scope of this invention. Both compositions included a polymeric binder that contained urethane acrylate moieties but the polymeric binder did not include ethylenically unsaturated side chains.

A formulation was prepared by dissolving or dispersing 4.8 g of non-UV curable Bayhydrol® 124 dispersion, 0.2 g of IB-05, 0.05 g of S0507, 0.5 g of Pigment A, and 0.4 g of FluorN™ 2900 (5% in PGME) in 3.5 g of PGME, 1.2 g of BLO, 5.7 g of acetone, 1 g of methanol, and 0.6 g of water. This comparative formulation was applied to an electrochemically grained and sulfuric acid anodized aluminum substrate that had been post-treated with poly(vinyl phosphoric acid) to provide a dry coating weight of about 1.2 g/m². The formulation was applied using a wire-wound rod and then dried for approximately 60 seconds in a Ranar conveyor oven set at 120° C.

For Comparative Example 3, the resulting element was placed on a CREO Trendsetter® 3244× imagesetter and exposed to an 830 nm IR laser at energies of 20 to 200 mJ/cm². The exposed element was then developed with 956 Developer at 23° C. There was no imaged generated in the exposures of 20 to 200 mJ/cm².

For Comparative Example 4, a topcoat formulation was applied, comprising 4 g of Elvanol® 5105, 4 g of IPA, 92 g of water, and 0.04 g of Masurf® FS-1520 to provide a dry coating weight of about 0.4 g/m², using the same conditions as above, the resulting two layer element was placed on a CREO Trendsetter® 3244× image setter and exposed to an 830 nm IR laser. The exposed element was then developed with 956 Developer at 23° C. There was no imaged generated in the exposures of 20 to 200 mJ/cm².

### Comparative Example 5

Still another comparative composition was prepared outside the scope of this invention. This composition was not radiation-sensitive because it did not include a initiator composition even though a primary polymeric binder as defined above was included.

A formulation was prepared by dissolving or dispersing 4.2 g of Bayhydrol® UV VPLS 2317 dispersion, 0.07 g of IRT, 0.3 g of Pigment A, and 0.5 g of FluorN™ 2900 (5% in PGME) in 6.0 g of PGME and 6.0 g acetone. This comparative formulation was applied to an electrochemically grained and sulfuric acid anodized aluminum substrate that had been post-treated with poly(vinyl phosphoric acid) to provide a dry coating weight of about 1.2 g/m². On each resulting layer, a topcoat formulation was applied, comprising 4 g of Elvanol® 5105, 4 g of IPA, 92 g of water, and 0.02 g of Masurf® FS-1520 to provide a dry coating weight of about 0.4 g/m². Both formulations were applied using a wire-wound rod and then dried for approximately 60 seconds in a Ranar conveyor oven set at 120° C.

The resulting element was placed on a CREO Trendsetter® 3244× image setter and exposed to an 830 nm IR laser. The exposed element was then developed in a N34 processor charged with 956 Developer at 23° C. There was no imaged generated in the exposures of 20 to 200 mJ/cm².

### Example 14

### Negative-Working Imageable Element and Imaging Method—Two Layers

An imageable layer formulation was prepared by dissolving or dispersing 1.93 g of Bayhydrol® UV VPLS 2280 dispersion, 0.2 g of Sartomer 399, 0.2 g of NK ester A-DPH, 0.6 g of SR415, 0.1 g of Phosmer PE, 0.15 g of IB-05, 0.09 g of IR Dye A, and 0.4 g of FluorN™ 2900 (5% in PGME) in 6 g of methyl lactate, 11 g of acetone, and 2 g of water. The imageable layer formulation was applied to an electrochemically grained and sulfuric acid anodized aluminum substrate that had been post-treated with poly(vinyl phosphoric acid) to provide a dry coating weight of about 0.9 g/m². On the resulting imageable layer, a topcoat formulation comprising 4 g of Elvanol® 5105, 4 g of IPA, 92 g of water, and 0.02 g of Masurf® FS-1520 was applied to provide a dry coating weight of about 0.4 g/m². Both formulations were applied using a wire-wound rod and then dried for approximately 60 seconds in a Ranar conveyor oven set at 120° C.

The resulting imageable element was placed on a CREO Trendsetter® 3244× image setter and exposed using an 830 nm IR laser. The imaged element was mounted on an ABDick duplicator press charged with fountain solution containing Varn Litho Etch 142 W at 3 oz./gal. (23.4 ml/liter) and PAR alcohol replacement at 3 oz./gal. (23.4 ml/liter) and van Son Rubber Base black ink VS 151. The imaged element was developed after 150 impressions under the application of the both fountain solution and ink and another 200 impressions were printed and showed good images using exposure energies as low as 90 mJ/cm².

### Example 15

### Negative-Working Imageable Element and Imaging Method—Two Layers

An imageable layer formulation was prepared by dissolving or dispersing 1.2 g of Bayhydrol® UV VPLS 2317 dispersion, 1.3 g of Polymer B, 0.2 g of Sartomer 399, 0.2 g of NK ester A-DPH, 0.6 of SR-415, 0.1 g of Phosmer PE, 0.15 g of IB-05, 0.09 g of IR Dye A, 0.3 g of Zonyl® FSN-100 (5% in PGME) and 0.3 g of FluorN™ 2900 (5% in PGME) in 3 g of water, 12 g of n-propanol, and 3 g of methanol. This formulation was applied to an electrochemically grained and sulfuric acid anodized aluminum substrate that had been post-treated with poly(vinyl phosphoric acid) to provide a dry coating weight of about 0.9 g/m². On the resulting imageable layer, a topcoat formulation comprising 4 g of Elvanol® 5105, 4 g of IPA, 92 g of water, and 0.02 g of Masurf® FS-1520 was applied to provide a dry coating weight of about 0.4 g/m². Both formulations were applied using a wire-wound rod and then dried for approximately 60 seconds in a Ranar conveyor oven set at 120° C.

The resulting imageable element was placed on a CREO Trendsetter® 3244× image setter and exposed using an 830 nm IR laser. The imaged element was mounted on an ABDick duplicator press charged with fountain solution containing Varn Litho Etch 142 W at 3 oz/gal (23.4 ml/liter) and PAR alcohol replacement at 3 oz/gal (23.4 ml/liter) and van Son Rubber Base black ink VS 151. The imaged element was developed after 25 impressions under the application of the both fountain solution and ink and another 200 impressions were printed and showed strong images of both solid and highlights using exposure energies as low as 50 mJ/cm².

### Example 16

### Negative-Working Imageable Element and Imaging Method—Two Layers

An imageable layer formulation was prepared by dissolving or dispersing 1.98 g of Bayhydrol® UV VPLS 2282 dispersion, 0.2 g of Sartomer 399, 0.2 g of NK ester A-DPH, 0.6 g of SR415, 0.15 g of IB-05, 0.09 g of IR Dye A, and 0.4 g of FluorN™ 2900 (5% in PGME) in 4.5 of PGME, 10 g of MEK, 1.5 g of water and 2 g of methanol. The imageable layer formulation was applied to an electrochemically grained and sulfuric acid anodized aluminum substrate that had been post-treated with poly(vinyl phosphoric acid) to provide a dry coating weight of about 0.9 g/m². On the resulting imageable layer, a topcoat formulation comprising 4 g of Elvanol® 5105, 4 g of IPA, 92 g of water, and 0.02 g of Masurf® FS-1520 was applied to provide a dry coating weight of about 0.4 g/m². Both formulations were applied using a wire-wound rod and then dried for approximately 60 seconds in a Ranar conveyor oven set at 120° C.

The resulting imageable element was placed on a CREO Trendsetter® 3244× image setter and exposed using an 830 nm IR laser. The imaged element was mounted on an ABDick duplicator press charged with fountain solution containing Varn Litho Etch 142 W at 3 oz/gal (23.4 ml/liter) and PAR alcohol replacement at 3 oz/gal (23.4 ml/liter) and van Son Rubber Base black ink VS 151. The imaged element was developed after 25 impressions under the application of the both fountain solution and ink and another 200 impressions were printed and showed good images using exposure energies as low as 90 mJ/cm².

### Examples 17 and 18

### Negative-Working Imageable Element and Imaging Method—Violet

For Example 17, a coating formulation was prepared as described in TABLE I below and applied to electrochemically grained, sulfuric acid-anodized aluminum that had been post-treated with a monosodium phosphate solution containing sodium fluoride. The coating was dried to a film weight of 1.54 g/m². The plate was then coated with a solution consisting of 5.64% poly(vinyl alcohol) (88% hydrolyzed), 0.3% poly(vinyl pyrrolidone), 3.76% isopropanol, and 90.3% water and dried to a film weight of 1.9 g/m². The resulting plate was imaged on a Fuji Luxel Vx-9600 platesetter at a series of exposures from 1.8 to 185 μJ/cm² and processed with 955 Developer (Eastman Kodak Company). The minimum exposure to produce a uniform solid was 15 μJ/cm² while an exposure of 21 μJ/cm² was sufficient to produce 8×8 pixel patterns measuring 51% in area. The plate was then mounted on an ABDick 9870 duplicator printing press and used to print 200 impressions without any degradation of either the solid or 8×8 pixel patterns.

For Example 18, a formulation of 14.2% Colloid 140 (available from Kemira Chemicals, Kennesaw, Ga.), 4.3% phosphoric acid, and 1.3% Surfactant 10G (available from Arch Chemicals, Norwalk, Conn.) in water was applied to a brush-grained phosphoric acid-anodized aluminum metal sheet and dried to a final coating weight of 0.03 g/m². A coating formulation prepared as described in TABLE I was then applied to the sub-coated substrate and was dried to provide an imageable layer with a film weight of 1.47 g/m². The plate was then coated with a solution consisting of 5.64% poly(vinyl alcohol) (88% hydrolyzed), 0.3% poly(vinyl pyrrolidone), 3.76% isopropanol, and 90.3% water and dried to a film weight of 1.9 g/m². The resulting plate was imaged on a Fuji Luxel Vx-9600 platesetter at a series of exposures from 1.8 to 185 μJ/cm² and processed with 956 Developer. The minimum exposure to produce a uniform solid was 44 μJ/cm² while an exposure of 132 μJ/cm² was sufficient to produce 8×8 pixel patterns measuring 54% in area. The plate was mounted on an ABDick 9870 printing press and was used to print 200 impressions without any degradation of either the solid or 8×8 pixel patterns.

TABLE I

| Component | Example 17 | Example 18 |
|---|---|---|
| Bayhydrol ® UV VP LS 2280 | 6.17 | 0 |
| Laromer ™ LR 9005 | 0 | 12.59 |
| Sartomer 349 | 1.16 | 0 |
| Oligomer 1 | 3.86 | 0 |
| Phosmer PE | 0.07 | 0 |
| 2-Phenyl-5-(4-diethylaminophenyl)-4-(2- | 0.70 | 0.79 |
| chlorophenyl)oxazole | | |
| 2,2′-Bis(2-chlorophenyl)-4,4′,5,5′- | 0.23 | 0.25 |
| tetraphenylbiimidazole | | |
| 3-Mercapto-1,2,4-triazole | 0.41 | 0.46 |
| Pigment A | 1.12 | 1.46 |
| Byk ® 307 | 0.01 | 0.01 |
| 1-Methoxy-2-propanol | 65.68 | 63.94 |
| 2-Butanone | 20.60 | 20.50 |

The following test was carried out to determine the solvent resistance of various UV-curable polyurethane dispersions.

The test was carried out by adding 0.1 g (solid) of the various dispersions into testing solvents and shaking the dispersions for 24 hours at 20° C. Two solvents were employed in this test: an 80% aqueous solution of 2-butoxyethanol (BC), and an 80% aqueous solution of 4-hydroxy-4-methyl-2-pentanone (DAA). The following TABLE TI shows the solubility of some UV-curable primary polymeric binder dispersions in these two solvents.

TABLE II

| Particulate Dispersion | 80% BC in Water | 80% DAA in Water |
|---|---|---|
| Bayhydrol ® UV VPLS | No | No |
| 2280 | | |
| Bayhydrol ® UV VPLS | No | No |
| 2282 | | |
| Bayhydrol ® UV VPLS | No | Yes |
| 2317 | | |
| Bayhydrol ® UV VPLS | No | Yes |
| 2348 | | |
| Bayhydrol ® UV XP | No | No |
| 2420 | | |
| Laromer ™ LR 8949 | No | No |
| Laromer ™ LR 8983 | No | Yes |
| Laromer ™ LR 9005 | No | No |

These results show that the particulate primary polymer binders useful in the present invention have desired solvent resistance. They are particularly resistant to 2-butoxyethanol.

The invention has been described in detail with particular reference to certain preferred embodiments thereof, but it will be understood that variations and modifications can be effected within the spirit and scope of the invention.

1. A radiation-sensitive composition comprising:
an initiator composition capable of generating free radicals sufficient to initiate polymerization of free radically polymerizable groups upon exposure to imaging radiation,
a radiation absorbing compound, and
a particulate primary polymeric binder that has a backbone comprising multiple urethane moieties and further comprises free radically polymerizable side chains attached to said backbone, wherein said primary polymeric binder comprises at least 2 and up to 20 aliphatic or aromatic acrylate side chains comprising ethylenically unsaturated groups per molecule, and said primary polymeric binder further comprises carboxy, sulfo, or phospho groups either attached directly to said backbone or attached as cart of side chains other than said free radically polymerizable side chains.

2. (canceled)

3. The composition of claim 1 further comprising:
a) a secondary free radically polymerizable component containing free radically polymerizable groups that is not said primary polymeric binder,
b) a secondary polymeric binder, or
both a) and b).

4. The composition of claim 3 that comprises b) but not a).

5. The composition of claim 1 wherein said primary polymeric binder is substantially free of unreacted isocyanate functional groups.

6. (canceled)

7. The composition of claim 1 wherein said primary polymeric binder is self crosslinkable.

8. The composition of claim 1 wherein said primary polymeric binder has a molecular weight of at least 100,000.

9. The composition of claim 1 wherein said particulate primary polymeric binder has an average particle size of from about 10 to about 300 nm, and is present in said composition in an amount of at least 10% based on the total composition dry weight.

10. The composition of claim 1 wherein 0.1 g of said primary polymeric binder remains insoluble when agitated for 24 hours at 20° C. in an aqueous solution of 2-butoxyethanol or 4-hydroxy-4-methyl-2-pentanone (20° % water).

11. The composition of claim 1 wherein said primary polymeric binder further comprises hydrophilic groups either attached directly to said backbone or attached as part of side chains other than said free radically polymerizable side chains.

12. (canceled)

13. An imageable element comprising a substrate having thereon an imageable layer comprising:
an initiator composition capable of generating free radicals sufficient to initiate polymerization of free radically polymerizable groups upon exposure to imaging radiation,
a radiation absorbing compound, and
a particulate primary polymeric binder that has a backbone comprising multiple urethane moieties and further comprises free radically polymerizable side chains attached to said backbone,
said imageable element optionally also comprising an overcoat disposed over said imageable layer, wherein said primary polymeric binder comprises at least 2 and up to 20 aliphatic or aromatic acrylate side chains comprising ethylenically unsaturated groups per molecule, and said primary polymeric binder further comprises carboxy, sulfo, or phospho groups either attached directly to said backbone or attached as part of side chains other than said free radically polymerizable side chains.

14. The element of claim 13 further comprising:
a) a secondary free radically polymerizable component comprising free radically polymerizable groups that is not said primary polymeric binder,
b) a secondary polymeric binder, or
both a) and b).

15. The element of claim 13 wherein said imageable layer consists essentially of:
an initiator composition capable of generating free radicals sufficient to initiate polymerization of free radically polymerizable groups upon exposure to imaging radiation,
a radiation absorbing compound, and
a said particulate primary polymeric binder has a backbone comprising multiple urethane moieties.

16. The element of claim 13 wherein said primary polymeric binder has an average particle size of from about 10 to about 300 nm, and is present in said imageable layer in an amount of at least 10 % and up to 90% based on the total imageable layer dry weight.

17. The element of claim 13 wherein said primary polymeric binder is substantially free of unreacted isocyanate functional groups.

18. (canceled)

19. The element of claim 13 wherein said primary polymeric binder has a molecular weight of from about 2,000 to about 500,000.

20. (canceled)

21. The element of claim 13 wherein said radiation absorbing compound comprises an infrared radiation sensitive compound having a λₘₐₓ of from about 700 to about 1400 nm, or comprises a sensitizer having a λ_{,ax} of from about 150 to about 475 nm.

22. The imageable element of claim 13 wherein said imageable layer comprises:
a) a triazine initiator and optionally a mono- or polycarboxylic acid or mercaptan as a co-initiator,
b) a boron-containing counterion that comprises four of the same or different alkyl or aryl groups, or any combination thereof, wherein said boron-containing counterion is a counterion for an infrared radiation absorbing dye, or is a counterion in an onium salt,
c) an iodonium salt, or an iodonium salt in combination with either a mercaptotriazole or a metallocene, wherein said iodonium salt optionally comprises a boron-containing counterion, or
d) any combination of these.

23. The element of claim 13 wherein said substrate is an aluminum-containing substrate having a hydrophilic surface upon which said imageable layer is disposed.

24. A method comprising:
A) imagewise exposing the imageable element of claim 13 using imaging radiation to produce exposed and non-exposed regions, and
B) with or without a post-exposure baking step, developing said imagewise exposed element to remove only said non-exposed regions.

25. The method of claim 24 wherein step B is carried out on-press in the presence of a fountain solution, lithographic printing ink, or a combination thereof.

26. The method of claim 24 wherein step B is carried out off-press using an aqueous alkaline developer.

27. The method of claim 24 wherein said imageable element comprises a particulate primary polymeric binder that about 100,000 to about 300,000, is substantially free of unreacted isocyanate functional groups, and is self-crosslinkable.
